(19) United States
(12) Patent Application Publication
(10) Pub. No.: US 2012/0079429 A1
(43) Pub. Date: Mar. 29, 2012

(54) SYSTEMS AND METHODS FOR TOUCH-BASED MEDIA GUIDANCE

(75) Inventors: Paul T. Stathacopoulos, San Carlos, CA (US); Geoff Ehlers, Santa Rosa, CA (US); Carlos Araya, San Francisco, CA (US)

(73) Assignee: ROVI TECHNOLOGIES CORPORATION, Santa Clara, CA (US)

(21) Appl. No.: 13/242,663

(22) Filed: Sep. 23, 2011

Related U.S. Application Data
(60) Provisional application No. 61/386,462, filed on Sep. 24, 2010.

(51) Int. Cl. G06F 3/048

(52) U.S. Cl. 715/830

(57) ABSTRACT

Systems and methods are provided for navigating media content information using a media guidance application implemented on a portable device with a touch-sensitive display. A display screen with a media content information region, an availability region, and/or a media source region may be displayed on the touch-sensitive display. The user may interact with these regions and, specifically, with media tiles, a time selector, and a channel selector to navigate the media content information.

### CROSS REFERENCE TO RELATED APPLICATION

This application claims the benefit of U.S. Provisional Patent Application No. 61/386,462, filed Sep. 24, 2010, which is hereby incorporated by reference herein in its entirety.

### BACKGROUND OF THE INVENTION

This invention relates generally to interactive media guidance applications, and more particularly, to systems and methods for providing media content guidance on a device with a touch-sensitive display.

With society awash in media content, and as such media content becomes ever more widely available, advanced media guidance application support is becoming increasingly important. At the same time, the development of touch-sensitive display technology is driving the need for media guidance applications that harness the unique interface features provided by a touch-sensitive device to provide an immersive and user-friendly guidance environment.

### SUMMARY OF THE INVENTION

In view of the foregoing, systems and methods for providing media content guidance on a touch-sensitive device are provided. The systems and methods described below include techniques for navigating media information using a media guidance application implemented on a portable device with a touch-sensitive display.

For example, a display screen with a media asset information region and an availability information region may be displayed on the touch-sensitive display. A portion of a selectable list of media objects, each representing a different media asset, may be displayed in the media asset information region of the display screen. The media objects may be arranged linearly and adjacent to one another, e.g., in a row. Parallel to the selectable list of media objects, a selector may be displayed in the availability information region of the display screen. In one embodiment, the selector includes multiple selector positions each corresponding to a different time. In another embodiment, the selector includes multiple selector positions each corresponding to a media source. The selector may also include a slider that indicates one of the selector positions.

In one approach, in response to receiving a user actuation of the touch-sensitive display at a location within the media asset information region, the selectable list of media objects may scroll (e.g., left or right) to display another portion of the selectable list of media objects. In response to receiving a user actuation of the touch-sensitive display at a location within the availability information region, the position of the slider may change to indicate a different selector position. In addition, the selectable list of media objects may be replaced with a second selectable list of media objects, where the second selectable list includes media objects that represent media assets available at the time or media source corresponding to the newly indicated selector position.

In an embodiment, the selector is a time selector and each of the selector positions corresponds to a different time. In this embodiment, the media objects in the selectable list represent media assets available from different media sources at the time corresponding to the indicated selector position. Furthermore, a selectable element in the availability information region of the display screen may be displayed. In response to a user actuation of the touch-sensitive display at a location within the selectable element, the selector may be modified into a channel selector, so that each of the selector positions corresponds to a different media source. Moreover, the list of media objects may be replaced with another selectable list of media objects each representing media assets available at different times from the media source indicated in the channel selector.

In an alternative embodiment, the selector is a channel selector and each of the selector positions corresponds to a different media source. In this embodiment, the media objects in the selectable list represent media assets available at different times from the media source corresponding to the indicated selector position. Furthermore, a selectable element in the availability information region of the display screen may be displayed. In response to a user actuation of the touch-sensitive display at a location within the selectable element, the selector may be modified into a time selector, so that each of the selector positions corresponds to a different time. Moreover, the list of media objects may be replaced with another selectable list of media objects each representing media assets available from different media sources at the time indicated in the time selector.

In an embodiment, the direction in which to scroll the media objects is determined by identifying two actuated areas on the touch-sensitive display at different time instants, and comparing the relative locations of the actuated areas.

In an embodiment, progress indicators may be displayed in the media asset information region. Each progress indicator may indicate an elapsed time of one of the media assets and may be displayed adjacent to one of the media objects representing the corresponding media asset. The progress indicators may also scroll together with the media objects.

In an embodiment, each of the media objects is a media tile (e.g., a thumbnail or image tile) that identifies the corresponding media asset. The media tiles may be selectable, and in response to such a selection, a display screen that includes information associated with the media asset corresponding to the selected image tile may be displayed.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a perspective view of an exemplary media guidance application display screen presented on a touch-sensitive device according to an illustrative embodiment of the invention;

FIG. 2 shows a more detailed view of the media guidance application display screen of FIG. 1 according to an illustrative embodiment of the invention;

FIG. 3 shows a perspective view of another exemplary media guidance application display screen presented on a touch-sensitive device according to an illustrative embodiment of the invention;

FIG. 4 shows a more detailed view of the media guidance application display screen of FIG. 3 according to an illustrative embodiment of the invention;

FIG. 5 shows an exemplary media guidance display screen that provides celebrity information according to an illustrative embodiment of the invention;

FIG. 6 shows an exemplary media guidance display screen providing dual-axis media content navigational control according to an illustrative embodiment of the invention;

FIG. 7 shows an alternate view of the media guidance application display screen of FIG. 6 according to an illustrative embodiment of the invention;

FIG. 8 shows an exemplary media guidance application display screen that provides detailed media asset information according to an illustrative embodiment of the invention;

FIG. 9 shows an exemplary media guidance application display screen with a social media overlay according to an illustrative embodiment of the invention;

FIG. 10 shows another exemplary media guidance application display screen with a social media overlay according to an illustrative embodiment of the invention;

FIG. 11 shows an exemplary media guidance application display screen overlaid with a list of availability information for a media asset according to an illustrative embodiment of the invention;

FIG. 12 shows an exemplary media guidance application display screen illustrating the use of a search feature according to an illustrative embodiment of the invention;

FIG. 13 shows an exemplary media guidance application display screen displayed in response to a user selection of a search result according to an illustrative embodiment of the invention;

FIG. 14 shows an exemplary media guidance application display screen that may be displayed in response to a user selection of a thumbnail according to an illustrative embodiment of the invention;

FIG. 15 shows a touch-sensitive device according to an illustrative embodiment of the invention.

FIG. 16 shows a simplified diagram of an interactive media system according to an illustrative embodiment of the invention;

FIG. 17 shows a diagram of a cross-platform interactive media system according to an illustrative embodiment of the invention;

FIG. 18 shows an illustrative flow chart depicting an exemplary process for navigating media content information in a browse-by-channel mode according to an illustrative embodiment of the invention;

FIG. 19 shows three illustrative flow charts depicting exemplary processes for handling user interaction with a touch-sensitive display in a browse-by-channel mode according to an illustrative embodiment of the invention;

FIG. 20 shows an illustrative flow chart depicting an exemplary process for navigating media content information in a browse-by-time mode according to an illustrative embodiment of the invention;

FIG. 21 shows three illustrative flow charts depicting exemplary processes for handling user interaction with a touch-sensitive display in a browse-by-time mode according to an illustrative embodiment of the invention.

### DETAILED DESCRIPTION OF EMBODIMENTS

The introduction of tablet computers and other mobile devices with touch-sensitive displays has changed the way users find and interact with information. Specifically, users are increasingly relying on these types of devices to access and organize data, and to perform tasks previously reserved for more traditional user equipment devices, such as television equipment and personal computer systems. As used herein, the term “touch-sensitive device” includes any device with a touch-sensitive display suitable for displaying media content and for receiving user interaction via direct contact with the display. Examples of touch-sensitive devices include the IPAD, IPHONE, NOOK, and other tablet, e-reader, or mobile devices with touch-sensitive displays. IPAD and IPHONE are registered trademarks owned by Apple, Inc. NOOK is a registered trademark owned by Barnes & Noble, Inc. Touch-sensitive desktop and laptop computer screens, and touch-sensitive television screens, are also examples of touch-sensitive devices.

One area in which touch-sensitive devices are poised to change the way users find and interact with information is in the field of media guidance. The amount of media available to users in any given media delivery system may be substantial. Consequently, many users desire a form of media guidance through an interface that allows users to efficiently navigate through media selections and easily identify media content that they may desire. Touch-sensitive devices provide unique interface elements with which to accomplish these twin goals. In particular, touch-sensitive devices allow users to directly interact with media content selections depicted on a screen to quickly and efficiently locate information of interest.

An application which provides media content guidance is referred to herein as an interactive media guidance application or, sometimes, a media guidance application or a guidance application. Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), recorded programs, and other types of media or video content. Guidance applications also allow users to navigate among and locate content related to video content including, for example, video clips, audio assets, articles, advertisements, chat sessions, games, etc. Moreover, guidance applications allow users to navigate among and locate multimedia content. The term multimedia is defined herein as media content that utilizes at least two different content forms, such as text, audio, still images, animation, video, and interactivity content forms. Multimedia content may be recorded and played, displayed or accessed by information content processing devices, such as computerized and electronic devices, but may also be part of a live performance. It should be understood that the invention embodiments that are described in relation to media or media content are also applicable to other types of content, such as video, audio and/or multimedia.

In accordance with an embodiment of the present invention, users may navigate among and locate media content using a touch-sensitive device running a media guidance application. The media guidance application may be any suitable software application, e.g., running on a processor within the touch-sensitive device. For example, the media guidance application may be or include a JAVA applet executable on a mobile device. JAVA is a registered trademark owned by Sun Microsystems, Inc. More generally, the media guidance application may be, include, or be part of an application, a software module, or other suitable set of computer-readable instructions. The media guidance application may also be referred to, in some instances, as an “app.” In an embodiment, the media guidance application may execute remotely, e.g., on a processor located in one or more servers, and the results may be transmitted to, and displayed on, the touch-sensitive device. Generally, the media guidance application may be provided as an on-line application (i.e., provided on a web-site), a stand-alone application or client, or as a distributed application capable of running on multiple processors or devices.

In addition to search and identification functions, media guidance applications may also be used to view, store, transmit, or otherwise interact with the media content. For example, after locating a media program of interest, a user may use the media guidance application to stream the media program over the internet. In should be understood that media applications running on a touch-sensitive device may perform any or all of the functions typically performed by media guidance applications running on television sets or set-top boxes. For example, a user may interact with a touch-sensitive device running a media guidance application to select television programs for recording using a digital video recorder (DVR), e.g., connected to a television. In addition, using these touch-sensitive devices, users are able to navigate among and locate the same media generally accessible through a television, computer system, or other suitable media device.

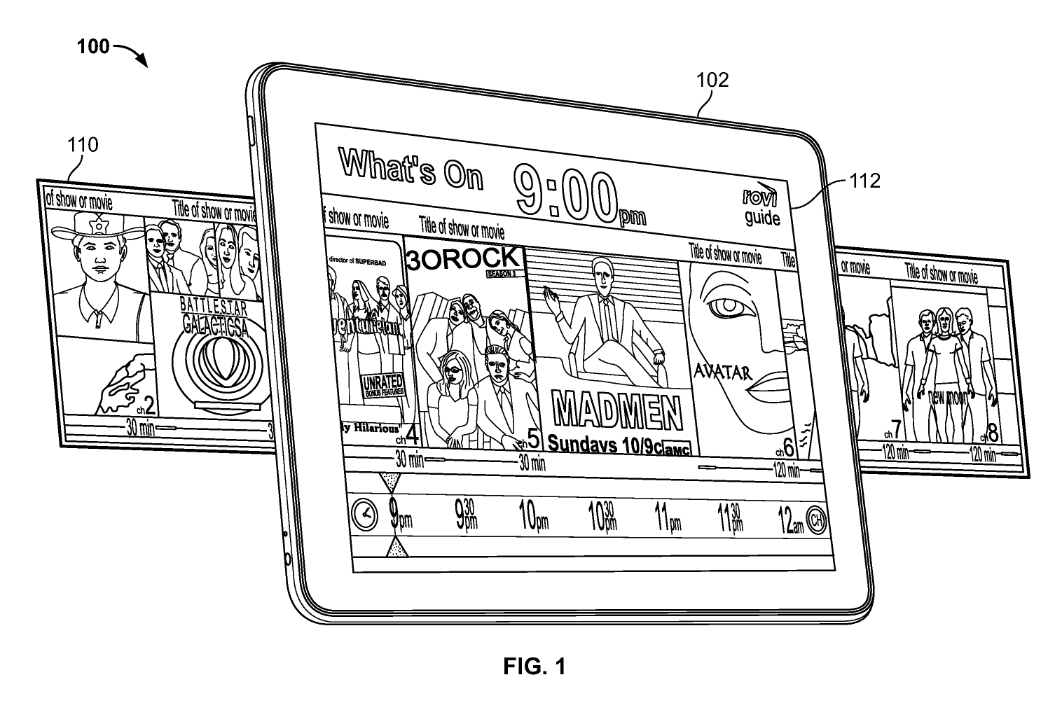

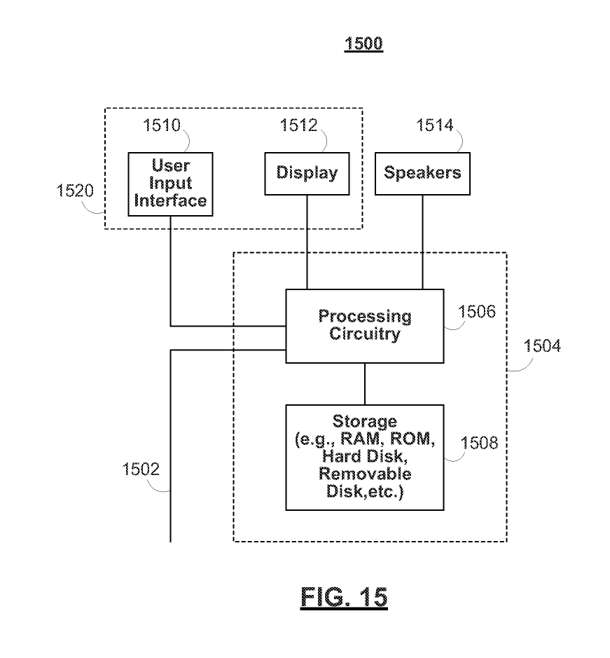

FIG. 1 shows a perspective view 100 of an exemplary media guidance application display screen 112 presented on a touch-sensitive device 102, in accordance with an embodiment of the present invention. The components of touch-sensitive device 102 are discussed below with reference to FIGS. 15-17. As shown, only a portion of available media content information may be displayed at any time. For example, a subset of media tiles 110 may be displayed within display screen 112. A user may interact with the display screen 112 to scroll linearly amongst the media tiles 110. In particular, the user may tap, flick, swipe, drag, or otherwise perform a gesture in the vicinity of media tiles 110. Generally, the user interacts with the touch-sensitive display of the touch-sensitive device using a digit. However, any suitable human or hardware interface element, such as a stylus, may be used.

Media tiles 110 may be thumbnails, cover art, or any other visual indication associated with media content. When a user interacts with media tiles 110, e.g., by indicating a desire to scroll the information left or right, display screen 112 may update accordingly. For example, the user may touch the display at a location of a media tile and make a flicking gesture towards the left in order to move the list of media tiles 110 to the left, thereby revealing additional media tiles to the right. Similarly, as another example, the user may touch the display at a location of a media tile and make a flicking gesture towards the right in order to move the list of media tiles 110 to the right, thereby revealing additional media tiles to the left. The speed and/or extent of the scrolling may depend, in some embodiments, on the speed of the user flicking gesture. It should be understood that any suitable gesture may be used to scroll media tiles 110, such as a dragging or sliding gesture. It should also be understood that media tiles 110 may be arranged vertically or horizontally (as depicted) and may therefore scroll up and down or left and right, respectively. Furthermore, although depicted as a single row of tiles, media tiles 110 may include two or more rows (and/or columns) of media tiles.

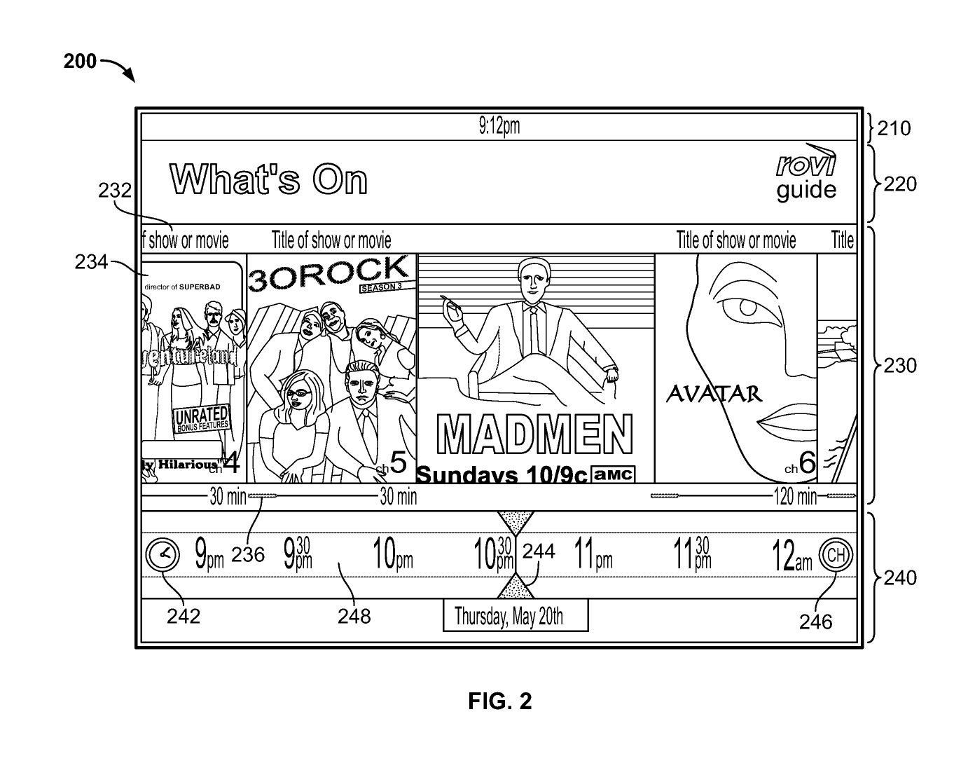

FIG. 2 shows an exemplary display screen 200 corresponding to a more detailed view of media guidance application display screen 112 of FIG. 1, in accordance with an embodiment of the present invention. As shown, display screen 200 may include a number of regions, such as regions 210, 220, 230, and 240. Region 210 is located at the top of the screen and may display time and/or date information, status messages, advertisements, logos, or any other suitable information. Region 220 is located below region 210 and may display header information. Header information may include one or more of the application title (e.g., “What's On”), advertisements, logos, or other suitable information. Region 230 is located below region 220 and may display media content information for a number of media assets. Media content information may include one or more of a title, cover art, a source (e.g., channel) indicator, availability (e.g., broadcast) time information, and any other information related to media assets. As shown, region 230 may include title information 232 and media tiles 234. Title information 232 may include the title of the respective media asset and/or other identifying information (e.g., channel, rating, parental control settings, etc.). Media tiles 234 may be thumbnails, cover art, or any other visual indication associated with the respective media asset. Region 230 may also include indicators 236, which may indicate the elapsed time of the respective media asset (e.g., progress indicators) and/or the total duration of the media asset.

Region 240 is located below region 230 and may display a time selector and/or a channel selector. In one embodiment, as shown, region 240 includes a time selector with a number of selector positions, where each selector position corresponds to a different time of day (e.g., 9 PM, 9:30 PM, 10 PM, etc.). For example, each selector position may correspond to a time 30 minutes later than the time represented by the immediately preceding selector position. Furthermore, the time represented by each selector position may be displayed adjacent to the respective selector position, or the time may be displayed as the selector position itself (as shown). Thus, the time selector is displayed as a linear, horizontal display of time information, e.g., in increments of 30 minutes. In another embodiment, region 240 includes a media source selector with a number of selector positions, where each selector position corresponds to a different media source (e.g., a different channel, network, website, video streaming service, etc.). For example, each selector position may correspond to a different channel in the channel line-up offered by the user's cable television provider. Furthermore, an indication (e.g., channel number, network name, logo, etc.) of the media source represented by each selector position may be displayed adjacent to the respective selector position, or an indication of the media source may be displayed as the selector position itself (as shown). Thus, the media source selector is displayed as a linear, horizontal display of media source information, e.g., CBS, NBC, ABC, etc.

Region 240 may also include selectable elements 242 and 246 for changing which selector is displayed. Specifically, element 242 may cause the time selector to be displayed in region 240 in place of the media source selector, and element 246 may cause the media source selector to be displayed in region 240 in place of the time selector. In other embodiments, only one of selectable elements 242 and 246 is displayed and can be toggled by the user to switch between the time selector and the media source selector.

Region 240 may also include a slider 244 for indicating a particular selector position. Slider 244, for instance, may indicate a particular time in the time selector or a particular media source in the media source selector. In one embodiment, as shown, slider 244 may indicate a selector position by being positioned, at least in part, over that selector position. However, it should be understood that any suitable display mechanism may be used to associated slider 244 with a selector position. In one approach, for example, slider 244 is actualized by highlighting or shading a particular selector position. In another approach, slider 244 may be a border displayed around a particular selector position. Slider 244 may also display additional information related to the indicated selector position. For example, slider 244 may display a date associated with the indicated selector position.

In an embodiment, slider 244 is fixed at a particular location on the screen and a selector position is indicated by scrolling the selector so that the desired selector position appears beneath, adjacent to, or otherwise visually distinguished by the selector. For example, if the time selector currently indicates a time of 10:30 PM, and a user selects 11 PM, the time selector may scroll to the left so that 11 PM appears indicated by slider 244. In another embodiment, slider 244 is a moveable element. That is, slider 244 may be moved through interaction with the touch-sensitive device to any of the selector positions displayed in region 240. For example, a user may drag and drop the slider onto a desired selector position by interacting with the touch-sensitive screen of the device. In one approach, the selector may then scroll, and slider 244 may be repositioned, so that the newly indicated selector position and the slider are displayed at the center of display region 240.

When display screen 200 is initially displayed to the user, slider 244 may be positioned over a default selector position. The default selector position for the time selector may be determined from the current time. For example, the default selector position may be the selector position corresponding to the time closest to the current time, or the time closest to, but preceding, the current time. The default selector position for the media source selector may be pre-set or may be determined from a user profile. For example, the default selector position may be the selector position corresponding to a media source most often accessed by the user (as indicated in the user profile), or it may correspond to a media source determined to be popular for a number of users. It should be understood that the default selector position may be determined using any suitable technique and any suitable criteria, which may involve user viewing history data and/or a pre-set designation received from a remote server. When a user subsequently views display screen 200, the slider may be returned to the selector position at which it was last positioned.

In an embodiment, the media content information displayed in region 203 corresponds to the selector position indicated by slider 244. When the time selector is displayed, media content information is displayed for media assets available at the time designated by the slider position. For example, if slider 244 indicates 10:30 PM (as shown), region 203 may include television shows scheduled for broadcast at 10:30 PM, e.g., on a number of different channels. When the media source selector is displayed, on the other hand, media content information is displayed for media assets available from the media source designated by the slider position. For example, if slider 244 indicates NBC, region 203 may include television shows scheduled for broadcast on NBC, e.g., at different times throughout the day.

As such, when slider 244 is moved to indicate another selector position, the media content information displayed in region 203 may update accordingly. In particular, when the time selector is displayed and slider 244 is moved to a new position, the contents of region 230 are updated to display media content information for media assets available at the time designated by the new slider position. Alternatively, when the media source selector is displayed and slider 244 is moved to a new position, the contents of region 230 are updated to display media content information for media assets available from the media source designated by the new slider position. In this manner, slider 244 in region 240 may be used to select a particular time or media source, and corresponding media content information may be viewed by the user in region 230.

As discussed in connection with FIG. 1, the media content information in region 230 is scrollable, e.g., to the left or right, using gestures. The media content information displayed is associated with a number of media assets that corresponding to the indicated time or media source in region 240. Accordingly, scrolling the media content information reveals additional media content information associated with other media assets that correspond to the indicated time or media source in region 240. For example, scrolling the contents of region 230 displays additional media tiles for available television programs or videos. Similarly, the time selector and media source selector in region 240 are scrollable. In particular, the user may interact with the touch-sensitive screen in the vicinity of the selector in order to scroll the selector, e.g., using gestures. For example, the user may slide or flick the selector. In response, the selector may scroll (e.g., to the right or left) so that additional selector positions are revealed and a new selector position is indicated by slider 244. In one approach, after the selector scrolls, the nearest selector position may snap to slider 244, thereby centering that selector position in region 240. The selector position nearest slider 244 therefore becomes the indicated selector position and the contents of region 230 update accordingly.

In another approach, instead of using slide or flick gestures to reposition the selector, the user may simply tap a selector position. In response, the selector scrolls so that the selector position at the location of the user's tap is positioned at the location of slider 244, and hence becomes the indicated selector position. Regardless of the mechanism used to set the desired selector position, the contents of region 230 update whenever a new selector position is indicated, as described above.

It should be understood that one or more of regions 210, 220, 230, and 240 may be rearranged. For example, region 240 may be displayed above region 230. In some embodiments, the relative arrangement of the regions is user-configurable. It should also be understood that one or more of regions 210, 220, 230, and 240 may be omitted, or that an additional region may be displayed in display screen 200. For example, a dual-view screen may be displayed that includes another region similar to region 230, but for another time or channel. This would allow a user to compare media content information (e.g., listings information) for two different time periods or for two different channels.

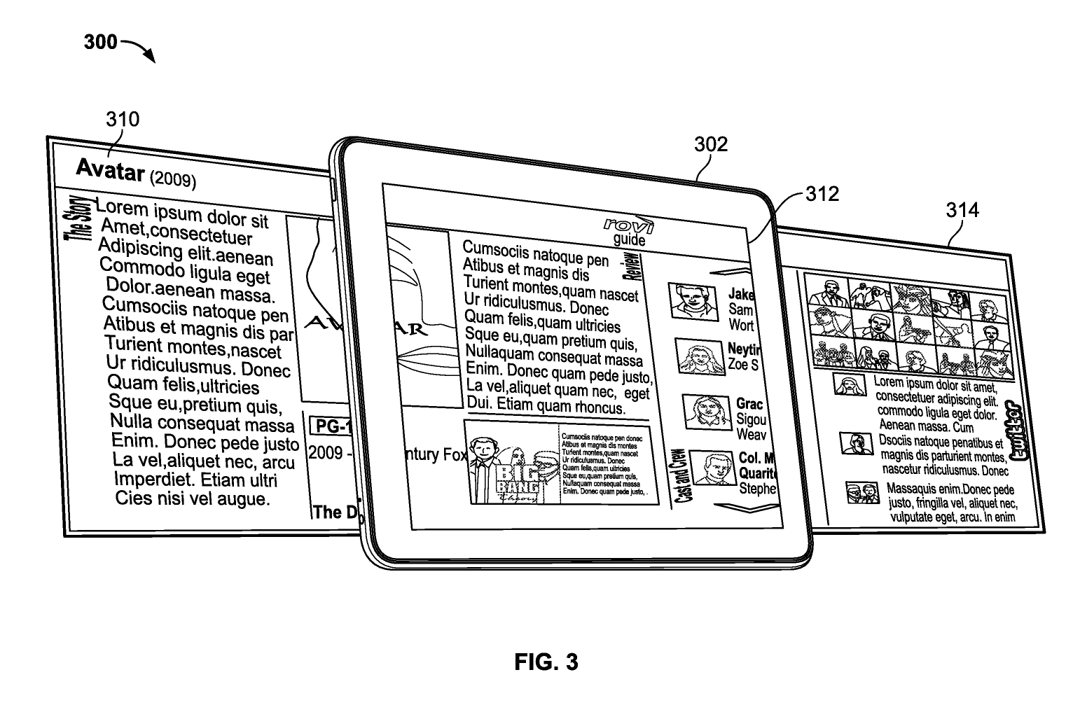

FIG. 3 shows a perspective view 300 of an exemplary media guidance application display screen 312 presented on a touch-sensitive device 302, in accordance with an embodiment of the present invention. The components of touch-sensitive device 302 are discussed below with reference to FIGS. 15-17. As shown, only a portion of available media content information may be displayed at any time. For example, display screen 312 may extend past the boundaries of the available display region of touch-sensitive device 302. A user may therefore interact with the device to move display screen 312, e.g., right or left, so that additional content is displayed to the user.

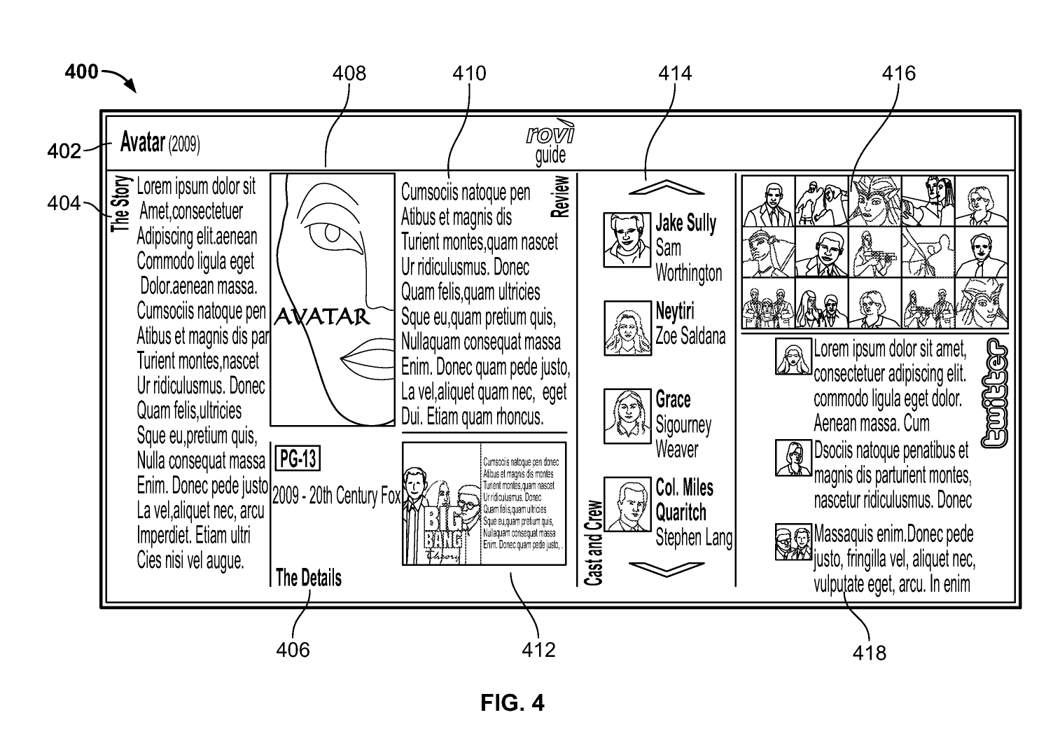

FIG. 4 shows an exemplary display screen 400 corresponding to a more detailed view of media guidance application display screen 312 of FIG. 3, in accordance with an embodiment of the present invention. Display screen 400 is an exemplary display screen providing pertinent information associated with a media asset, e.g., a movie or television program. As shown, display screen 400 may include a number of regions, such as regions 402, 404, 406, 408, 410, 412, 414, 416 and 418. Region 402 displays title information for the media asset, e.g., a movie title. Region 402 may also display other identifying information related to the media asset, such as an associated date, season, episode, rating, etc. Region 404 displays a synopsis or description of the media asset. The text within region 404 may be scrollable, e.g., up and down, using the touch-sensitive interface of the device. Region 406 displays media asset details, which may include an associated title, date, season, episode, rating, parental control setting, etc. Region 408 displays cover art or an image associated with the media asset.

Continuing with FIG. 4, region 410 displays one or more reviews of the media asset, e.g., from a critic or other viewer. The text within region 410 may be scrollable, e.g., up and down, using the touch-sensitive interface of the device. Region 412 displays an advertisement, which may be interactive. The advertisement may be selected based on any suitable criteria, such as user demographics, preferences or viewing history (e.g., as stored in the user profile). In one approach, the advertisement is related to the media asset. Region 414 displays a list of the cast and crew featured in, or associated with, the media asset. The list of cast and crew within region 414 may be scrollable, e.g., up and down, using the touch-sensitive interface of the device. In addition each individual entry in the list may be selectable, e.g., using a tap gesture. In one approach, upon receiving a user selection of a cast and crew entry, information about the individual is displayed. This information may be presented, for example, in another media guidance display screen or in an overlay displayed over display screen 400.

Region 416 of display screen 400 displays thumbnails of images associated with the media asset. For example, the images may be still photographs captured from a movie. A user may tap on an individual thumbnail to view the image in a larger size, or to perform other functions involving the image (e.g., attaching the image to an email). In addition, the thumbnails within region 416 may be scrollable, e.g., up and down and/or left and right, using the touch-sensitive interface of the device. A user may scroll the thumbnails in region 416 in order to view additional thumbnails associated with the media asset. Finally, region 418 displays comments from other users regarding the media asset or the cast and crew featured in region 414. For example, region 418 may display comments posted on TWITTER, FACEBOOK, or another online service. TWITTER is a registered trademark of Twitter, Inc. FACEBOOK is a registered trademark of Facebook, Inc. The comments within region 418 may be scrollable, e.g., up and down, using the touch-sensitive interface of the device.

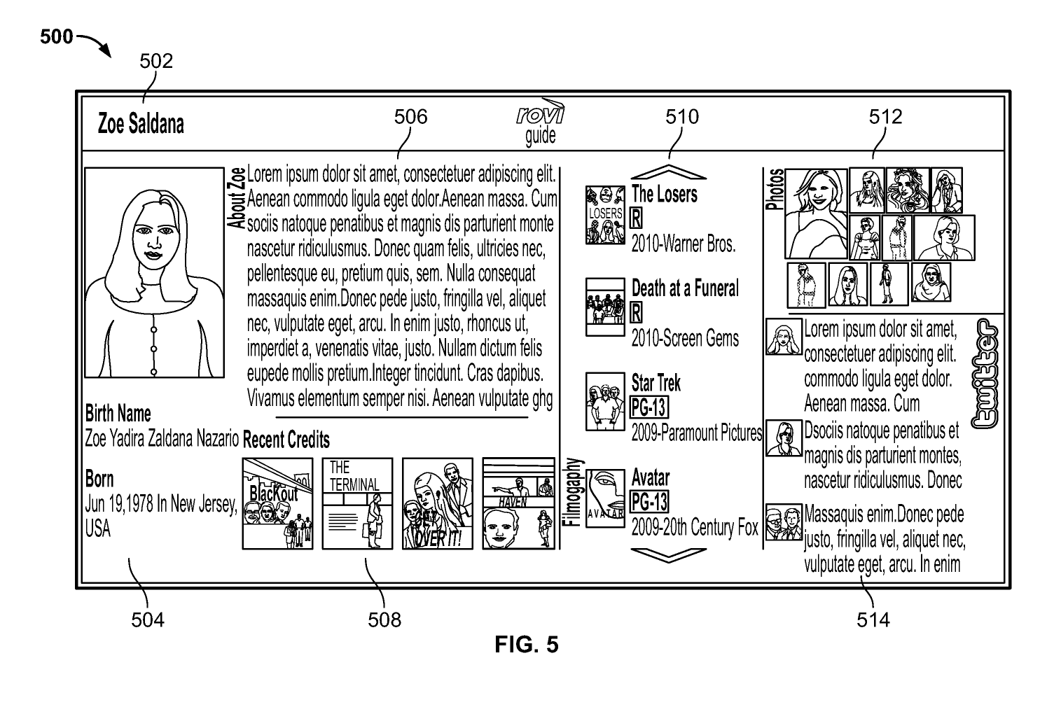

FIG. 5 shows another exemplary media guidance display screen 500 that may be viewed on a touch-sensitive device in accordance with an embodiment of the present invention. Display screen 500 is an exemplary display screen providing pertinent information associated with an individual, e.g., an artist, actor or actress.

As shown, display screen 500 may include a number of regions, such as regions 502, 504, 506, 508, 510, 512 and 514. Region 502 displays the individual's name, while region 504 displays other identifying information, such as birth date, birth name, a photograph, etc. Region 506 displays biographical information, and may be scrollable using the touch-sensitive interface of the device. Regions 508 and 510 display recent credits and filmography information, respectively. For example, regions 508 and 510 may display movies or shows the individual is associated with or featured in. Regions 508 and 510 may be scrollable using the touch-sensitive interface of the device. Region 512 displays thumbnails of photographs associated with the individual. A user may tap on an individual thumbnail to view the photograph in a larger size, or to perform other functions involving the photograph. In addition, the thumbnails within region 512 may be scrollable, e.g., up and down and/or left and right, using the touch-sensitive interface of the device. A user may scroll the thumbnails in region 512 in order to view additional thumbnails associated with the individual. Finally, region 514 displays comments from other users regarding the individual, e.g., as posted to an online service. The comments within region 514 may be scrollable using the touch-sensitive interface of the device.

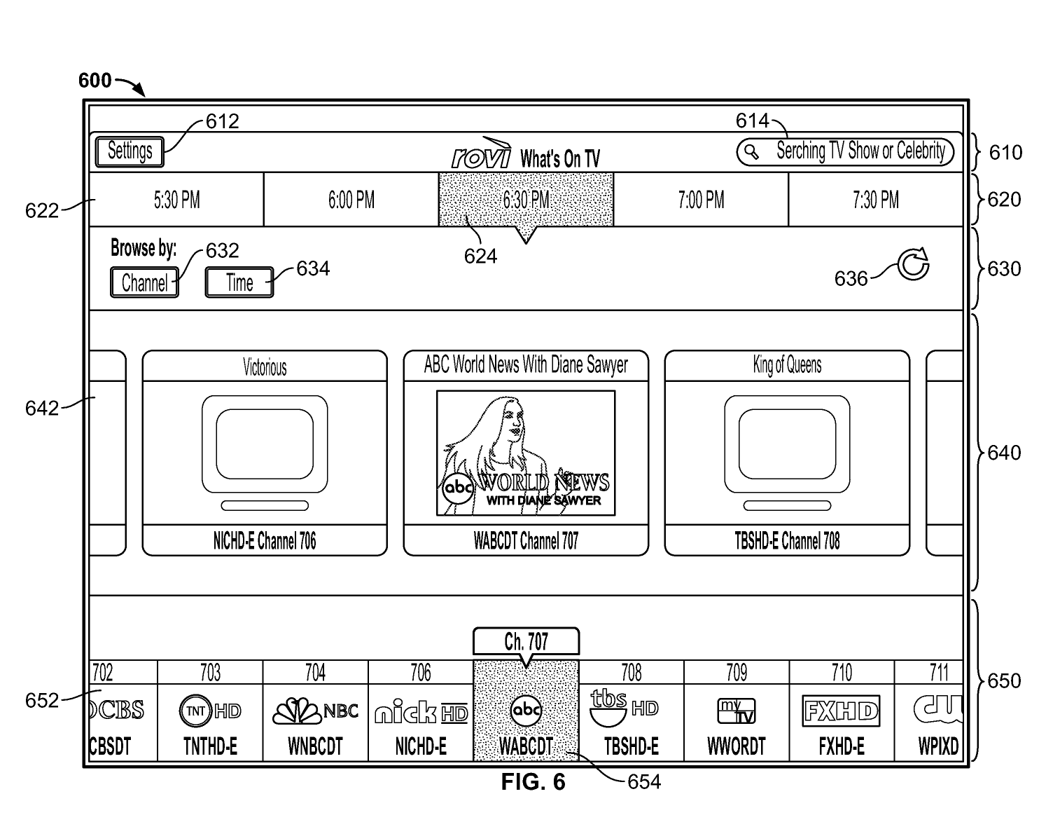

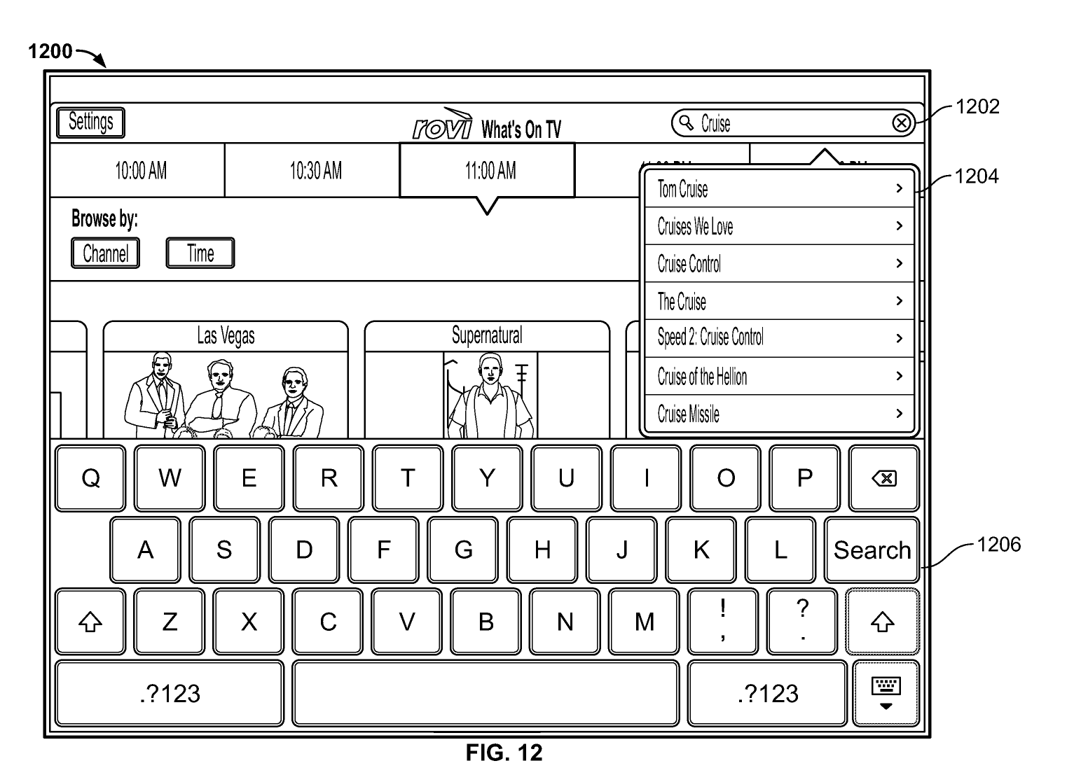

FIG. 6 shows an exemplary media guidance display screen 600 that may be viewed on a touch-sensitive device in accordance with an embodiment of the present invention. Display screen 600 may serve as an alternative, for instance, to display screen 200 of FIG. 2. As shown, display screen 600 may include a number of regions, such as regions 610, 620, 630, 640 and 650. Region 610 may be located at the top of the screen and may include a settings button 612, an application logo and/or title, and/or a search textbox 614. Settings button 612 may provide the user with access to set various preferences. These preference settings my include the user's geographical location and/or cable provider. Search textbox 614 may allow the user to search for media asset information and celebrity information. The function of search textbox 614 will be discussed in greater detail below in connection with FIG. 12. Region 610 may also include other suitable information, such as advertisements.

Region 620 is located below region 610 and may display time selector 622. As shown, time selector 622 includes a number of selector positions arranged adjacent to one another in a row, where each selector position corresponds to a different time of day (e.g., 5:30 PM, 6:00 PM, 6:30 PM, etc.). In one embodiment, the selector positions correspond to sequential times in 30-minute increments. Region 620 also includes a time slider 624 for indicating a particular selector position in the time selector (e.g., a particular time). In one embodiment, as shown, slider 624 indicates a selector position by being disposed, at least in part, over that selector position. However, it should be understood that any suitable display mechanism could be used to associate time slider 624 with a selector position in time selector 622. In one approach, for example, highlighting or shading a particular selector position actualizes slider 624. In another approach, slider 624 may be a border displayed around a particular selector position. Time slider 624 may also display additional information related to the indicated selector position. For example, time slider 624 may display a date or other information associated with the indicated selector position.

In an embodiment, time selector 622 is scrollable within region 620. In particular, the user may interact with the touch-sensitive screen in the vicinity of time selector 622 in order to scroll the time selector, e.g., using gestures. For example, the user may slide or flick time selector 622 to initiate the scrolling function. In response, time selector 622 may scroll (e.g., to the right or left) so that additional selector positions are revealed and time slider 624, which may itself remain stationary, indicates a new selector position. In one approach, after time selector 622 scrolls, the nearest selector position may snap to slider 624, thereby centering that selector position in region 620. In another approach, the scrolling function may be configured to ensure that the scrolling terminates with a selector position disposed at the location of slider 624. Regardless, the selector position that ultimately settles at the location of time slider 624 becomes the indicated selector position.

In another approach, instead of using slide or flick gestures to reposition time selector 622, the user may simply tap a selector position. In response, the time selector scrolls so that the selector position at the location of the user's tap is moved to the location of time slider 624, and hence becomes the indicated selector position. Upon indication of a new selector position in time selector 622, various regions of display screen 600 may update in concert, as will be discussed in greater detail below.

Region 630 is located below region 620 and may include channel button 632, time button 634, and refresh button 636. Channel button 632 and time button 634 modify browse settings for the media guidance application that generates display screen 600. The browse settings may control the information displayed in region 640, i.e., which media tiles are displayed and/or what information is displayed within the media tiles. The browse settings may also determine the scrolling behavior of time selector 622, media tiles 642, and media source selector 652 relative to one another. These display and behavioral changes are discussed in greater detail below.

In one approach, the browse settings indicate one of two possible settings: browse-by-channel and browse-by-time. The browse-by-channel setting allows the user to view and navigate amongst media content information for media assets available from different media sources (e.g., channels, video streaming servers, etc.) by interacting with media tiles 642 in region 640. The media content information may be limited, in this case, to media assets available at a particular time, e.g., the time indicated by time slider 624. On the other hand, the browse-by-time setting allows the user to view and navigate amongst media content information for media assets available at different times (e.g., 9 PM, 9:30 PM, 10 PM, etc.) by interacting with media tiles 642 in region 640. The media content information may be limited, in this case, to media assets available from a particular media source, e.g., the source indicated by media source slider 654.

The browse-by-channel setting may be selected by the user via channel button 632, and the browse-by-time setting may be selected by the user via time button 634. In other words, the user may toggle between the two buttons in order to switch between the two respective settings. The user may activate one of the buttons, for example, by tapping the desired button on the touch-sensitive display of the device. In response to an activation of one of buttons 632 and 634, the browse settings may be modified and a new set of media tiles may be displayed in region 640, or the information displayed within the existing media tiles 642 may change accordingly. The currently selected browse settings may be indicated on the display screen by visually distinguishing the corresponding button. For example, as shown in FIG. 6, channel button 632 appears depressed when compared to time button 634, indicating that the browse-by-channel settings are currently selected.

Refresh button 636 allows the user to restore display screen 600 to its default settings, and/or to reload the data containing the media guidance information displayed. In particular, upon user selection of refresh button 636, the data from which media content information is retrieved may be refreshed (e.g., retrieved from a local database or a remote server). This media content information may determine which media tiles are displayed in region 640, and the contents of those media tiles. Alternatively, or in addition, activation of refresh button 636 may cause time selector 622 and media source selector 652 to revert back to their default positions.

Region 640 is located below region 630 and may display media content information for a number of media assets. Media content information may include one or more of a title, cover art, a source (e.g., channel) indicator, availability time information (e.g., broadcast time), and any other information related to media assets. As shown, region 640 displays media tiles 642, each corresponding to a different media asset. Media tiles 642 may include a title and/or an image for the corresponding media asset, as shown. The images presented within media tiles 642 may be thumbnails, cover art, or any other visual indication associated with the respective media asset. Media tiles 642 may also include other information pertaining to the corresponding media asset, such as a rating, parental control settings, etc. Although not shown, media tiles 642 may also include progress and/or duration indicators to indicate, respectively, the elapsed time and total duration of the corresponding media asset.

Each of media tiles 642 may also include media source information (as shown) or time information associated with the corresponding media asset. In an embodiment, only one of media source information and time information is displayed within media tiles 642 depending on the browse settings. In this approach, media source information may be displayed when browse-by-channel is selected, while time information may be displayed when browse-by-time is selected. The current browse settings are indicated, as discussed above, by the currently selected one of channel button 632 and time button 634.

In an embodiment, at least one of media tiles 642 is active at all times. The active media tile is associated with the time and media source currently indicated by time slider 624 and channel slider 654. As such, the active media tile may appear centered within region 640 and/or centered beneath time slider 624 and/or centered above channel slider 654. In one approach, when the user taps on the active media tile, display screen 600 is replaced with another media guidance display screen presenting detailed information about the media asset represented by the active media tile. For example, display screen 800 may be displayed on the touch-sensitive device in response to a user selection of the active media tile. In another approach, detailed information about the media asset represented by the active media tile is displayed in an overlay over display screen 600, in response to the user selection. In yet another approach, options may be provided to the user in response to the user selection of the active media tile. These options may include, for example, an option to view the media asset, an option to store (e.g., download or record) the media asset, an option to set a reminder for the media asset, an option to buy the media asset, an option to add the media asset to a digital video recorder (DVR) record list, and/or any other suitable option.

In an embodiment, media tiles 642 are scrollable within region 640. In particular, the user may interact with the touch-sensitive screen in the vicinity of media tiles 642 in order to scroll the media tiles, e.g., right or left. For example, the user may perform a gesture on the touch-sensitive screen, such as a sliding or flicking gesture, to scroll the row of media tiles. In response to the gesture, the media tiles may scroll so that additional media tiles are revealed. In addition, scrolling media tiles 642 may cause a new media tile to become active. In one approach, the media tile positioned over a particular area of display screen 600 (e.g., the center of region 640) when the scrolling terminates becomes the active media tile. The scrolling function may be configured to ensure that the scrolling terminates with a media tile positioned over the aforementioned area. In another approach, each media tile becomes the active tile while it is positioned over a particular area of display screen 600 (e.g., the center of region 640). Consequently, when the scrolling ends and media tiles 642 come to rest, the last tile to be made active remains the active media tile.

In one embodiment, when the user taps a media tile other than the active media tile, the selected media tile becomes the active media tile. Media tiles 642 may then scroll so that the newly active media tile is centered within region 640. In another embodiment, when the user taps a media tile other than the active media tile, media tiles 642 scroll so that the selected media tile is positioned over a particular area of the display screen (e.g., centered in region 640). As described above, the selected media tile may become active upon being positioned over that area.

Region 650 is located below region 640 and may display channel selector 652. As shown, channel selector 652 includes a number of selector positions arranged adjacent to one another in a row, where each selector position corresponds to a different media source. For example, each selector position in channel selector 652 may correspond to a different television channel (e.g., channel 702, channel 703, channel 704, etc.). As another example, each selector position in channel selector 652 may correspond to a different television network (e.g., CBS, NBC, ABC, etc.). As yet another example, each selector position in channel selector 652 may correspond to a different Internet streaming service (e.g., HULU, NETFLIX, AMAZON, etc.). Region 650 also includes a channel slider 654 for indicating a particular selector position in the channel selector (e.g., a particular media source). In one embodiment, as shown, slider 654 indicates a selector position by being disposed, at least in part, over that selector position. However, it should be understood that any suitable display mechanism could be used to associate channel slider 654 with a selector position in channel selector 652. In one approach, for example, highlighting or shading the selector position actualizes slider 654. In another approach, slider 654 may be a border displayed around a particular selector position. Channel slider 654 may also display additional information related to the indicated selector position. For example, channel slider 654 may display a date, channel, source title, or other information associated with the indicated selector position.

In an embodiment, channel selector 652 is scrollable within region 650. In particular, the user may interact with the touch-sensitive screen in the vicinity of channel selector 652 in order to scroll the channel selector, e.g., using gestures. For example, the user may slide or flick channel selector 652 to initiate the scrolling function. In response, channel selector 652 may scroll (e.g., to the right or left) so that additional selector positions are revealed and channel slider 654, which may itself remain stationary, indicates a new selector position. In one approach, after channel selector 652 scrolls, the nearest selector position may snap to slider 654, thereby centering that selector position in region 650. In another approach, the scrolling function may be configured to ensure that the scrolling terminates with a selector position disposed at the location of slider 654. Regardless, the selector position that ultimately settles at the location of channel slider 654 becomes the indicated selector position.

In another approach, instead of using slide or flick gestures to reposition channel selector 652, the user may simply tap a selector position. In response, the channel selector scrolls so that the selector position at the location of the user's tap is moved to the location of channel slider 654, and hence becomes the indicated selector position. Upon indication of a new selector position in channel selector 652, various regions of display screen 600 may update in concert, as will be discussed in greater detail below.

When the browse-by-channel setting is selected, time selector 622 may serve to control which media content information is displayed and accessible in region 640. In particular, in this mode, the media guidance application may display media content information (e.g., media tiles 642) corresponding to media assets available from a variety of different media sources at a particular time of day, where the time of day is specified by the selector position indicated by time slider 624. The time indicated by time selector 622 therefore effectively limits the media content information displayed so that the user is only presented with information (e.g., media tiles) relevant for the indicated time. Time selector 622 also provides the user with an interface for updating the media content information displayed in region 640. For example, the user may scroll time selector 622 so that time slider 624 indicates a new time. In response, the information in region 640 may update so that media content information is displayed only for media assets available at the newly indicated time.

As an illustrative example, when the browse-by-channel setting is selected, the user may be presented with media tiles 642 corresponding to media assets available at 6:30 PM, the time indicated by time slider 624. The user may scroll and interact with media tiles 642, as described above. Then, the user may scroll time selector 622 so that slider 624 indicates a new selector position, thereby indicating a new time. In response, media tiles 642 may be automatically replaced with a different set of media tiles which correspond to media assets available at the newly indicated time. The user may scroll and interact with these new media tiles and/or select another time using time selector 622.

In one approach, when the user first loads display screen 600, the indicated time defaults to the current time. In this approach, the media content information displayed in region 640 may initially be limited to assets currently available. The user may then scroll time selector 622 to indicate a new time.

As described above, scrolling media tiles 642 can result in the activation of a new media tile. In the browse-by-channel mode, channel slider 654 may be synchronized with the currently active media tile. In particular, when a new media tile becomes active, channel selector 652 may automatically scroll so that the selector position indicated by channel slider 654 corresponds to the media source of the media asset represented by the active media tile. FIG. 6 provides an illustrative example. As shown in display screen 600, the browse-by-channel settings are selected, time slider 624 indicates a time of 6:30 PM, and the media sources are television channels. Media tiles 642 therefore correspond to television shows available on different channels at 6:30 PM. Also shown, the currently active media tile corresponds to a show available on channel 707, which is indicated in channel selector 652 by channel slider 654. If the user were to scroll media tiles 642 one tile to the left, the active media tile would then correspond to a show available on channel 708. In response, channel selector 652 would automatically scroll so that channel slider 654 indicates the new media source, i.e., channel 708.

Similarly, when channel selector 652 is scrolled by the user so that slider 654 indicates a new selector position, media tiles 642 may automatically scroll so that the active media tile corresponds to a media asset available from the indicated media source. For example, in FIG. 6, if a user causes channel slider 654 to indicate channel 710, media tiles 642 would automatically scroll to activate the media tile corresponding to a television show available from channel 710. In sum, the browse-by-channel mode allows the user to navigate amongst the media content information displayed in region 640 in at least two ways: by scrolling media tiles 642 or by scrolling channel slider 652. Either way, the display elements in regions 640 and 650 are responsive to one another and are thereby maintained in-synch. Specifically, media tiles 642 scroll in response to a newly indicated selector position in channel selector 652, and channel selector 652 scrolls in response to a newly active media tile in region 640. Ultimately, the media guidance application ensures that channel slider 654 indicates the media source providing the media asset corresponding to the active media tile.

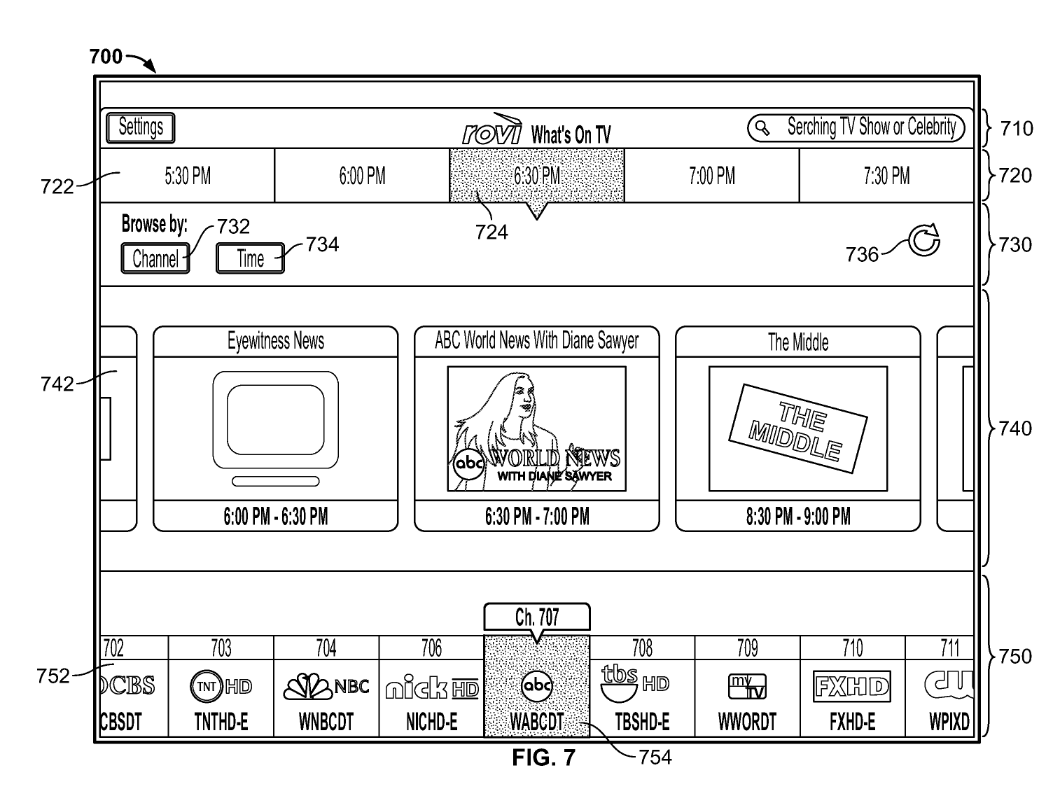

When the browse-by-time setting is selected, channel selector 652 may serve to control which media content information is displayed and accessible in region 640. For ease of explanation, however, the present discussion will refer to FIG. 7, which depicts an exemplary media guidance display screen 700. Display screen 700 is similar to display screen 600 of FIG. 6, with the exception that the browse-by-time setting is selected (as indicated by button 734). Regions 710, 720, 730, 740 and 750 correspond to regions 610, 620, 630, 640 and 650 of FIG. 6, respectively; selectors 722 and 752 correspond to selectors 622 and 652 of FIG. 6, respectively; sliders 724 and 754 correspond to selectors 624 and 654 of FIG. 6, respectively; and buttons 732, 734 and 736 correspond to buttons 632, 634 and 636 of FIG. 6, respectively. However, media tiles 742 may be different than media tiles 642 of FIG. 6. Specifically, since the browse-by-time setting is selected, region 740 displays media tiles corresponding to media assets available at different times of day from a particular media source.

In the browse-by-time mode, the media guidance application may display media content information (e.g., media tiles 742) corresponding to media assets available at different times of day from a particular media source, where the media source is specified by the selector position indicated by channel slider 754. The media source indicated by channel selector 752 therefore effectively limits the media content information displayed so that the user is only presented with information (e.g., media tiles) available from that media source. Channel selector 752 also provides the user with an interface for updating the media content information displayed in region 740. For example, the user may scroll channel selector 752 so that channel slider 754 indicates a new media source. In response, the information in region 740 may update so that media content information is displayed only for media assets available from the newly indicated source.

As an illustrative example, when the browse-by-time setting is selected, the user may be presented with media tiles 742 corresponding to media assets available on channel 707, the source indicated by channel slider 754. The user may scroll and interact with media tiles 742, as described above. Then, the user may scroll channel selector 752 so that slider 754 indicates a new selector position, thereby indicating a new media source. In response, media tiles 742 may be automatically replaced with a different set of media tiles which correspond to media assets available from the newly indicated media source. The user may scroll and interact with these new media tiles and/or select another media source using channel selector 752.

In browse-by-time mode, time slider 724 may be synchronized with the currently active media tile. In particular, when a new media tile becomes active, time selector 722 may automatically scroll so that the selector position indicated by time slider 724 corresponds to the time at which the media asset represented by the active media tile is available. FIG. 7 provides an illustrative example. As shown in display screen 700, the browse-by-time settings are selected and channel slider 754 indicates channel 707. Media tiles 742 therefore correspond to television shows available at different times on channel 707. Also shown, the currently active media tile corresponds to a show available at 6:30 PM, which is indicated in time selector 722 by time slider 724. If the user were to scroll media tiles 742 one tile to the left, the active media tile would then correspond to a show available at 8:30 PM. In response, time selector 722 would automatically scroll so that time slider 724 indicates the new time, i.e., 8:30 PM.

Similarly, when time selector 722 is scrolled by the user so that slider 724 indicates a new selector position, media tiles 742 may automatically scroll so that the active media tile corresponds to a media asset available at the indicated time. For example, in FIG. 7, if a user causes time slider 724 to indicate 6 PM, media tiles 742 would automatically scroll to activate the media tile corresponding to a television show available at 6 PM (i.e., “Eyewitness News”). In sum, the browse-by-time mode allows the user to navigate amongst the media content information displayed in region 740 in at least two ways: by scrolling media tiles 742 or by scrolling time slider 722. Either way, the display elements in regions 740 and 720 are responsive to one another and are thereby maintained in-synch. Specifically, media tiles 742 scroll in response to a newly indicated selector position in time selector 722, and time selector 722 scrolls in response to a newly active media tile in region 740. Ultimately, the media guidance application ensures that time slider 724 indicates the time at which the media asset corresponding to the active media tile is available.

The above discussion presents at least four different ways of navigating media content information. In a first approach, the user may select browse-by-channel mode (e.g., channel button 732), set time selector 722 to a desired time, and browse through media content information by interacting with media tiles 742. In this approach, channel selector 752 scrolls automatically so that the indicated selector position matches the currently active media tile. In a second approach, the user may select browse-by-channel mode (e.g., channel button 732), set time selector 722 to a desired time, and browse through media content information by interacting with channel selector 752. In this approach, media tiles 742 scroll automatically so that the active media tile matches the indicated selector position (i.e., the media source indicated by slider 754). In a third approach, the user may select browse-by-time mode (e.g., time button 734), set channel selector 752 to a desired media source, and browse through media content information by interacting with media tiles 742. In this approach, time selector 722 scrolls automatically so that the indicated selector position matches the currently active media tile. In a fourth approach, the user may select browse-by-time mode (e.g., time button 734), set channel selector 752 to a desired media source, and browse through media content information by interacting with time selector 722. In this approach, media tiles 742 scroll automatically so that the active media tile matches the indicated selector position (i.e., the time indicated by slider 724). It should be understood that a user may employ one or more of these approaches, or may switch between one or more of these approaches, as desired.

It should be understood that one or more of regions 610, 620, 630, 640, and 650 of FIG. 6 may be rearranged. For example, region 640 may be displayed above region 630. Similarly, one or more of regions 710, 720, 730, 740, and 750 of FIG. 7 may be rearranged. In some embodiments, the relative arrangement of the regions is user-configurable. It should also be understood that one or more of regions 610, 620, 630, 640, and 650 of FIG. 6, and one or more of regions 710, 720, 730, 740, and 750 of FIG. 7, may be omitted, or that an additional region may be displayed in display screens 600 and 700. For example, a dual-view screen may be displayed that includes another region similar to region 640, but for another time or media source. This would allow a user to compare media content information, for instance, for two different time periods or for two different sources.

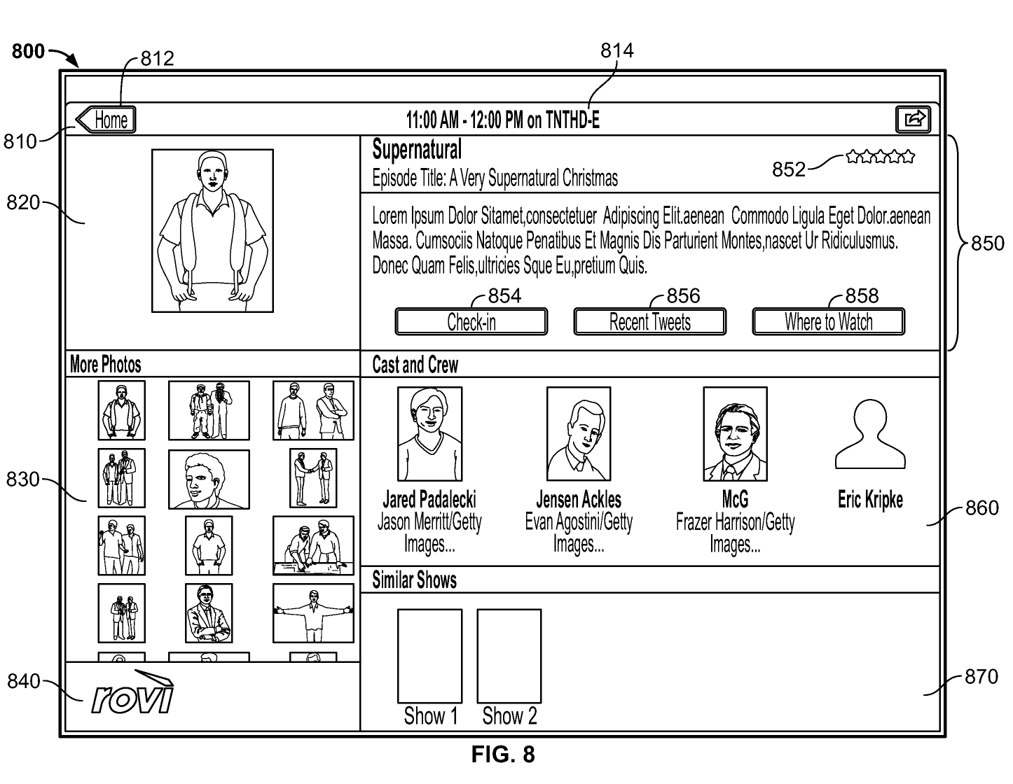

FIG. 8 shows an exemplary media guidance application display screen 800 presenting detailed information for a media asset, in accordance with an embodiment of the present invention. Display screen 800 may be displayed in response to a user selection of the media asset (e.g., via a user selection of the active media tile region 640 of FIG. 6). As shown, display screen 800 may include a number of regions, such as regions 810, 820, 830, 840, 850, 860, and 870. Region 810 is located at the top of the screen and may span the entire width of display screen 800. Region 810 may include a button 812 for returning to a home screen, e.g., display screen 600 of FIG. 6. Region 810 may also include media content information associated with the media asset. For example, region 810 may display the time and/or media source at which the media asset is available. Region 820 is located below region 810 and may include an image associated with the media asset. For example, the image may be a representative photograph, screenshot or cover art. Region 830 is located below region 820 and may include thumbnails of images associated with the media asset. For example, if the media asset is a television show, region 830 may present a thumbnail gallery of photographs form the show. The user may select any of the individual thumbnails to view a larger version of the image, e.g., in an overlay or in another display screen. Region 840 is located below region 830 and may include a title, logo, and/or other information associated with the media guidance application. For example, region 840 may display a logo for the media guidance application provider.

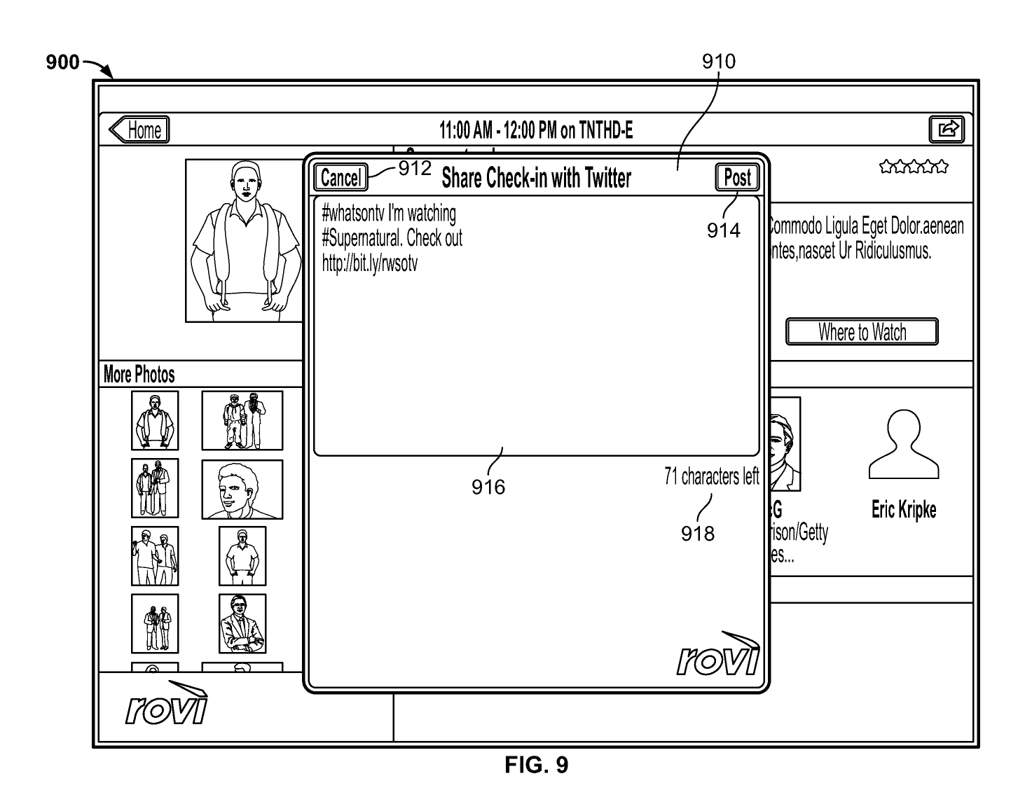

Continuing with FIG. 8, region 850 is located below region 810 and to the right of region 820. Region 850 may include title, heading, episode, series, and/or other suitable information identifying the media asset. Region 850 may also include a short description or synopsis associated with the media asset. In addition, region 850 may include ratings 852 and buttons 854, 856, and 858. Ratings 852 may indicate a critic's rating or an aggregate viewer rating. Alternatively, ratings 852 may be configurable by the user, so that the user can indicate a personal rating for the media asset. A rating assigned by the user may be stored in a user profile and/or transmitted to a remote server. The functionality of buttons 854, 856, and 858 will be described below in connection with FIGS. 9, 10, and 11, respectively. Region 860 is located below region 850 and to the right of region 830. Region 860 may include information on individuals associated with the creation or production of the media asset. For example, if the media asset is a television show or movie, region 860 may include information on the cast and crew featured in the show or movie. As another example, if the media asset is a song or music album, region 860 may include information on the musicians. Regardless, the information in region 860 may take the form of text, images, video, or multimedia content. As shown, for instance, region 860 may display pictures and names for each featured individual. Region 870 is located below region 860 and to the right of regions 830 and 840. Region 870 may include information for related media assets. For instance, if the media asset is a television show or movie, region 870 may provide information for similar shows or movies. The information in region 870 may take the form of text, images, video, or multimedia content. For example, thumbnails of cover art may be displayed for each related media asset. The user may select any of the thumbnails to retrieve additional information about the selected media asset.

It should be understood that one or more of regions 810, 820, 830, 840, 850, 860, and 870 may be rearranged or merged together. In some embodiments, the relative arrangement of the regions is user-configurable. It should also be understood that one or more of regions 810, 820, 830, 840, 850, 860, and 870 may be omitted and/or that an additional region may be displayed in display screen 800. Furthermore, one or more of regions 810, 820, 830, 840, 850, 860, and 870 may be scrollable to reveal additional information in that region. For example, if the number of thumbnails available for the media asset exceeds the display area of region 830, the user may scroll region 830 to reveal additional thumbnails. As such, each region may display only a portion of its content at any given time, and the regions may be independently scrolled without affecting the display of any other region.

FIG. 9 shows an exemplary media guidance application display screen 900 overlaid with a social media overlay 910, in accordance with an embodiment of the present invention. Display screen 900 may be substantially the same as display screen 800 of FIG. 8. In one approach, overlay 910 is displayed over display screen 900 in response to the user selecting button 854 of FIG. 8. The user may select button 854, for instance, using a tap gesture on the touch-sensitive screen of the device.

Overlay 910 may include interface elements providing an Internet-based social communication tool. Specifically, overlay 910 may include buttons 912 and 914, as well as text area 916. Button 912 may allow the user to close or hide the overlay without posting any comments to an online social networking service. Button 914, on the other hand, may allow the user to post comments to an online social networking service. The online social networking service may be any suitable Internet service that accepts user submissions. Examples of these types of online services include Google+, Twitter, and Facebook. In response to a user selection of button 914, the media guidance application may connect to the online social networking service using the user's account information, which may be stored in the user profile, and post the comments within text area 916. Text area 916 may allow the user to input text, images, video, or multimedia content. In an embodiment, the media guidance application may automatically pre-populate text area 916 with certain information. For example, text area 916 may be pre-populated with tags or links (e.g., internet addresses). One or more of these tags may include a reference to the media asset (i.e., the media asset discussed in connection with FIG. 8). In addition, for services, like Twitter, that restrict the number of characters that can be submitted in a single post, element 918 may display to the user the number of remaining characters that may be typed into text area 916 before reaching the maximum. The user may be automatically returned to display screen 800 of FIG. 8 after posting the contents of text area 916.

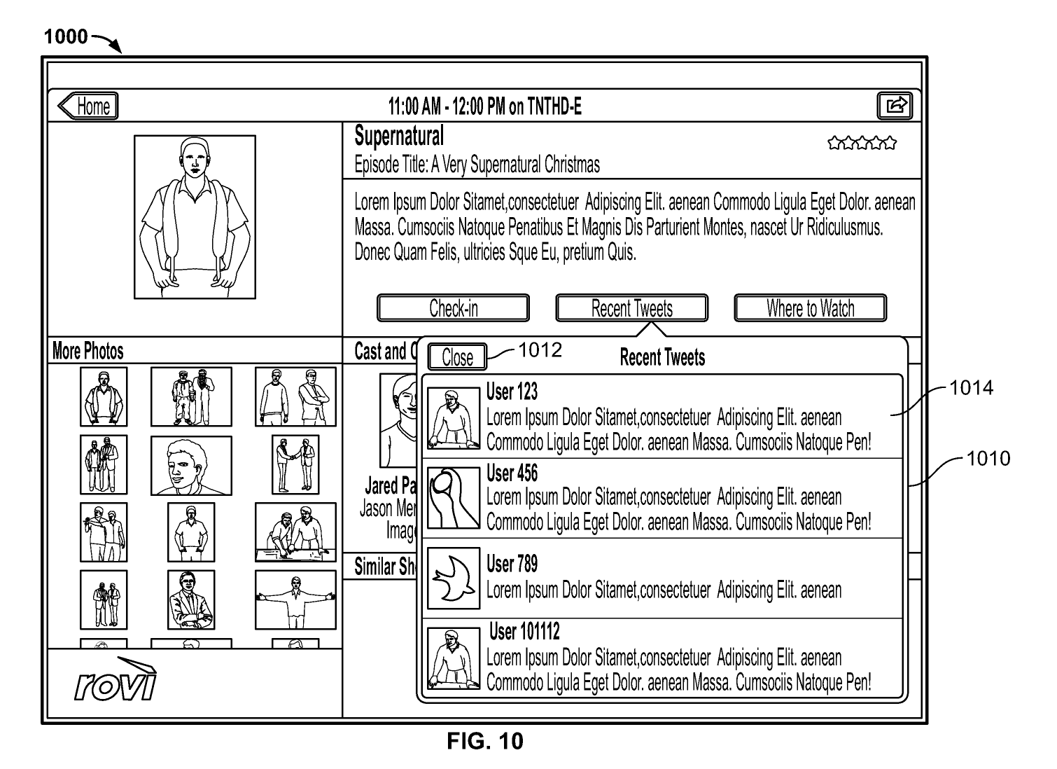

FIG. 10 shows an exemplary media guidance application display screen 1000 overlaid with a social media overlay 1010, in accordance with an embodiment of the present invention. Display screen 1000 may be substantially the same as display screen 800 of FIG. 8. In one approach, overlay 1010 is displayed over display screen 1000 in response to the user selecting button 856 of FIG. 8. The user may select button 856, for instance, using a tap gesture on the touch-sensitive screen of the device.

Overlay 1010 may present text, images, videos, or multimedia retrieved from an online social networking service, such as Google, Twitter, or Facebook. This data may be presented in a list of content 1014. Relevant content may be retrieved by searching the online social networking service for content associated with the media asset (i.e., the media asset discussed in connection with FIG. 8). For example, Twitter may be searched for “tweets” tagged with a reference associated with the media asset, and the results may be presented within list 1014. Moreover, overlay 1010 may retrieve and aggregate content from multiple online services. List 1014 may be scrollable so that the user may access additional items in the list, e.g., if overlay 1010 is not large enough to display all items. The user may close or hide overlay 1010 using button 1012.

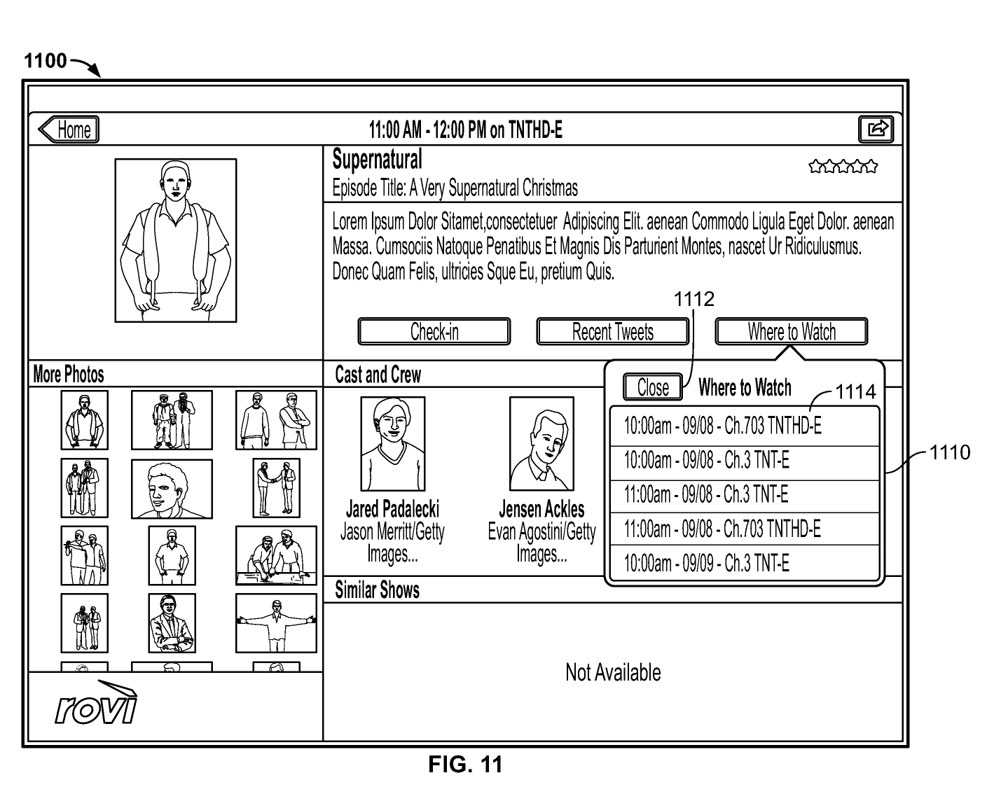

FIG. 11 shows an exemplary media guidance application display screen 1100 overlaid with a list of availability information, in accordance with an embodiment of the present invention. Display screen 1100 may be substantially the same as display screen 800 of FIG. 8. In one approach, overlay 1110 is displayed over display screen 1100 in response to the user selecting button 858 of FIG. 8. The user may select button 858, for instance, using a tap gesture on the touch-sensitive screen of the device.

Overlay 1010 may display a list 114 of availability information for the media asset (i.e., the media asset discussed in connection with FIG. 8). The availability information may include time, date, media source, and/or provider information. For example, if the media asset is a television show, list 1114 may display the show's scheduled broadcast times and/or the channels on which it will be broadcast. As another example, if the media asset is a video offered by multiple online streaming services, list 114 may display a list of these online services as well as any availability information (e.g., the list may indicate, for each service, whether the video is immediately available for streaming or download). In an embodiment, each item in list 1114 may be selectable and options may be provided to the user in response to a user selection of an item in the list. These options may include, for example, an option to view the media asset at the indicated media source, an option to store (e.g., download or record) the media asset from the indicated media source, an option to set a reminder for the media asset, an option to buy the media asset from the indicated media source, an option to add the media asset to a digital video recorder (DVR) record list, and/or any other suitable option. The user may close or hide overlay 1110 using button 1112.

FIG. 12 shows an exemplary media guidance application display screen 1200 illustrating the use of search bar 1202, in accordance with an embodiment of the present invention. Display screen 1200 may be substantially the same as display screen 600 of FIG. 6. In one approach, when the user activates search bar 1202, e.g., by tapping on the search bar, a virtual keyboard 1206 is displayed onscreen. The user may interact with the keys of virtual keyboard 1206 to type text into search bar 1202. In an embodiment, as the user types characters into search bar 1202, a list of anticipated results may be displayed in results list 1204. Results list 1204 may be generated by searching media content information for the text in search bar 1202. For example, as shown, if the user enters the term “Cruise” into search bar 1202, the media guidance application may display matching media information, i.e., media assets with a title that includes the term “Cruise,” celebrities with the a name that includes the term “Cruise,” etc. The results in list 1204 are selectable. In one approach, when a user selects an item from list 1204, another display screen is displayed that provides details on the media asset or individual associated with the selected item.

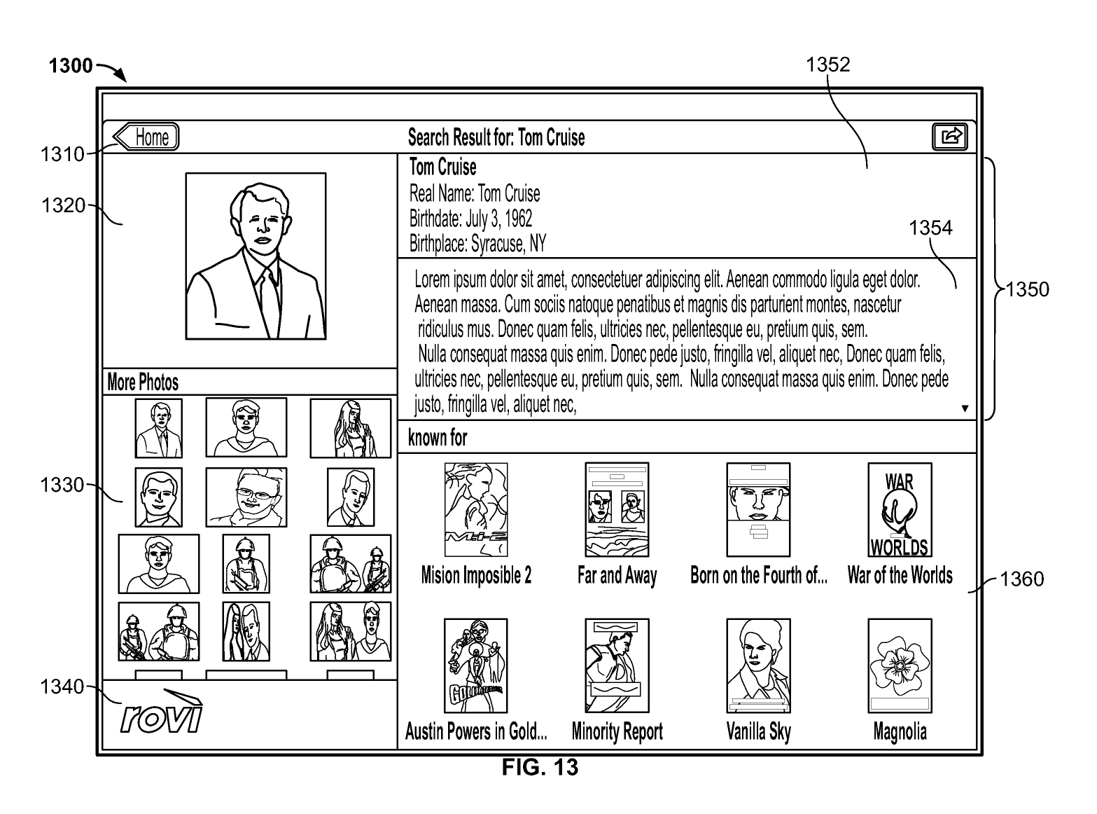

FIG. 13 shows an exemplary media guidance application display screen 1300 that may be displayed in response to a user selection of a search result within list 1204 of FIG. 12, in accordance with an embodiment of the present invention. Display screen 1300 is an exemplary display screen providing pertinent information associated with an individual, e.g., an artist, actor or actress, or other celebrity. For instance, if the user were to select “Tom Cruise” from list 1204 of FIG. 12, display screen 1300 may be displayed in response, providing details for the actor Tom Cruise. Of course, it should be understood that a different display screen (e.g., display screen 400 of FIG. 4 or display screen 800 of FIG. 8) may be displayed in response to the user selecting a media asset.

As shown, display screen 1300 may include a number of regions, such as regions 1310, 1320, 1330, 1340, 1350, and 1360. Region 1310 is located at the top of the screen and may span the entire width of display screen 1300. Region 1310 may include a button 1312 for returning to a home screen, e.g., display screen 800 of FIG. 8. Region 1310 may also include information associated with the search that caused display screen 1300 to be displayed, such as the search term. Region 1320 is located below region 1310 and may include an image associated with the individual. For example, the image may be a photograph of the individual. Region 1330 is located below region 1320 and may include thumbnails of images associated with the individual. For example, region 1330 may present a thumbnail gallery of photographs of the individual. The user may select any of the individual thumbnails to view a larger version of the image, e.g., in an overlay or in another display screen. Region 1340 is located below region 1330 and may include a title, logo, and/or other information associated with the media guidance application. For example, region 1340 may display a logo for the media guidance application provider.

Continuing with FIG. 13, region 1350 is located below region 1310 and to the right of region 1320. Region 1350 may include name, birth date, birthplace, and/or other identifying information associated with the individual. Region 1350 may also include a short biography associated with the individual. Region 1360 is located below region 1350 and to the right of regions 1330 and 1340. Region 1360 may include thumbnails and/or title information associated with media assets related to the individual. For example, if the individual is an actor, region 1360 may include thumbnails of movies featuring the actor. In an embodiment, the thumbnails of region 1360 are selectable. In response to a user selection, information related to the associated media asset may be displayed, e.g., in an overlay or another media guidance display screen.

It should be understood that one or more of regions 1310, 1320, 1330, 1340, 1350, and 1360 may be rearranged or merged together. In some embodiments, the relative arrangement of the regions is user-configurable. It should also be understood that one or more of regions 1310, 1320, 1330, 1340, 1350, and 1360 may be omitted and/or that an additional region may be displayed in display screen 1300. Furthermore, one or more of regions 1310, 1320, 1330, 1340, 1350, and 1360 may be scrollable to reveal additional information in that region. For example, if the number of thumbnails available for display in region 1360 exceeds the display area of region 13600, the user may scroll region 1360 to reveal additional thumbnails. As such, each region may display only a portion of its content at any given time, and the regions may be independently scrolled without affecting the display of any other region.

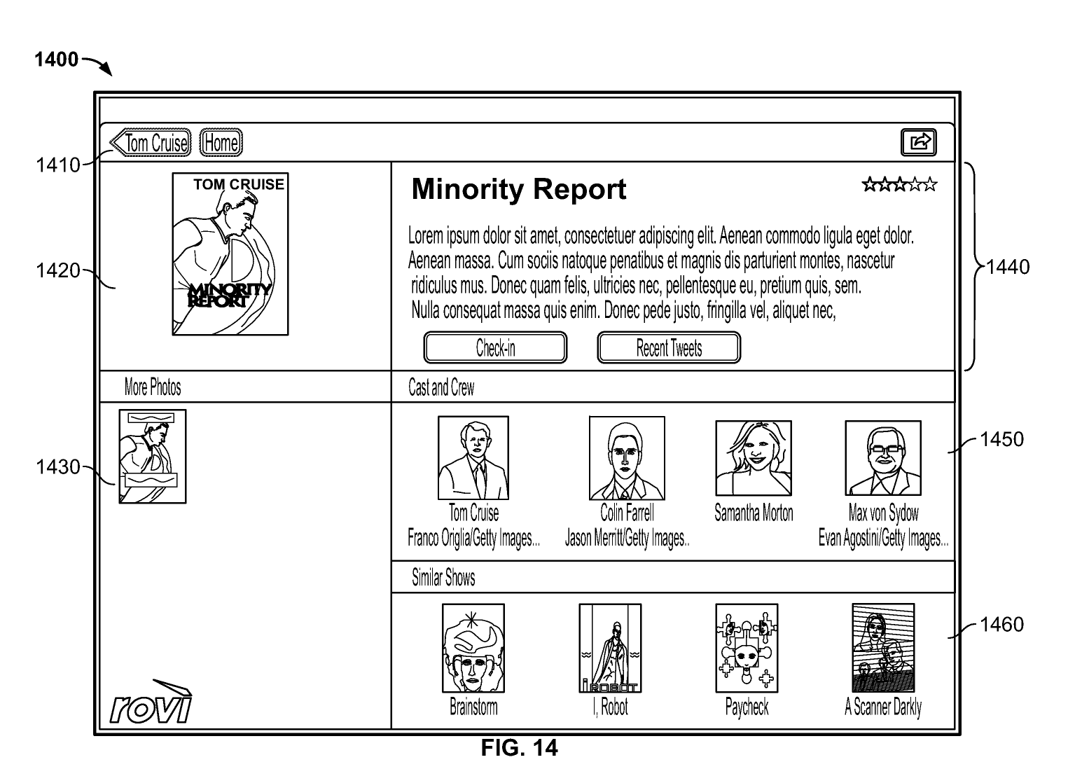

FIG. 14 shows an exemplary media guidance application display screen 1400 that may be displayed in response to a user selection of a thumbnail in region 1360 of FIG. 13, in accordance with an embodiment of the present invention. Display screen 1400 presents detailed information for the media asset associated with the selected thumbnail, e.g., a movie, television show, album, song, e-book, or other textual, video or audio asset. As shown, display screen 1400 may include a number of regions, such as regions 1410, 1420, 1430, 1440, 1450, and 1460. Region 1410 is located at the top of the screen and may span the entire width of display screen 1400. Region 1410 may include a button for returning to a home screen, e.g., display screen 800 of FIG. 8, and a button for going back to a previous display screen, e.g., display screen 1300 of FIG. 13.

Region 1420 is located below region 1410 and may include an image associated with the media asset. For example, the image may be a representative photograph, screenshot or cover art. Region 1430 is located below region 1420 and may include thumbnails of images associated with the media asset. For example, if the media asset is a movie, region 1430 may present a thumbnail gallery of photographs form the movie. The user may select any of the individual thumbnails to view a larger version of the image, e.g., in an overlay or in another display screen. Region 1430 may also include a title, logo, and/or other information associated with the media guidance application. For example, region 1430 may display a logo for the media guidance application provider.

Continuing with FIG. 14, region 1440 is located below region 1410 and to the right of region 1420. Region 1440 may include title, heading, episode, series, and/or other suitable information identifying the media asset. Region 1440 may also include a short description or synopsis associated with the media asset. In addition, region 1440 may include a ratings element and buttons, similar to those described in connection with FIG. 8. Region 1450 is located below region 1440 and to the right of region 1430. Region 1450 may include information on individuals associated with the creation or production of the media asset. For example, if the media asset is a television show or movie, region 1450 may include information on the cast and crew featured in the show or movie. As another example, if the media asset is a song or music album, region 1450 may include information on the musicians. Regardless, the information in region 1450 may take the form of text, images, video, or multimedia content. As shown, for instance, region 1450 may display pictures and names for each featured individual. Region 1460 is located below region 1450 and to the right of region 1430. Region 1460 may include information for related media assets. For instance, if the media asset is a television show or movie, region 1460 may provide information for similar shows or movies. The information in region 1460 may take the form of text, images, video, or multimedia content. For example, thumbnails of cover art may be displayed for each related media asset. The user may select any of the thumbnails to retrieve additional information about the selected media asset.

It should be understood that one or more of regions 1410, 1420, 1430, 1440, 1450, and 1460 may be rearranged or merged together. In some embodiments, the relative arrangement of the regions is user-configurable. It should also be understood that one or more of regions 1410, 1420, 1430, 1440, 1450, and 1460 may be omitted and/or that an additional region may be displayed in display screen 1400. Furthermore, one or more of regions 1410, 1420, 1430, 1440, 1450, and 1460 may be scrollable to reveal additional information in that region. For example, if the number of thumbnails available for the media asset exceeds the display area of region 1430, the user may scroll region 1430 to reveal additional thumbnails. As such, each region may display only a portion of its content at any given time, and the regions may be independently scrolled without affecting the display of any other region.

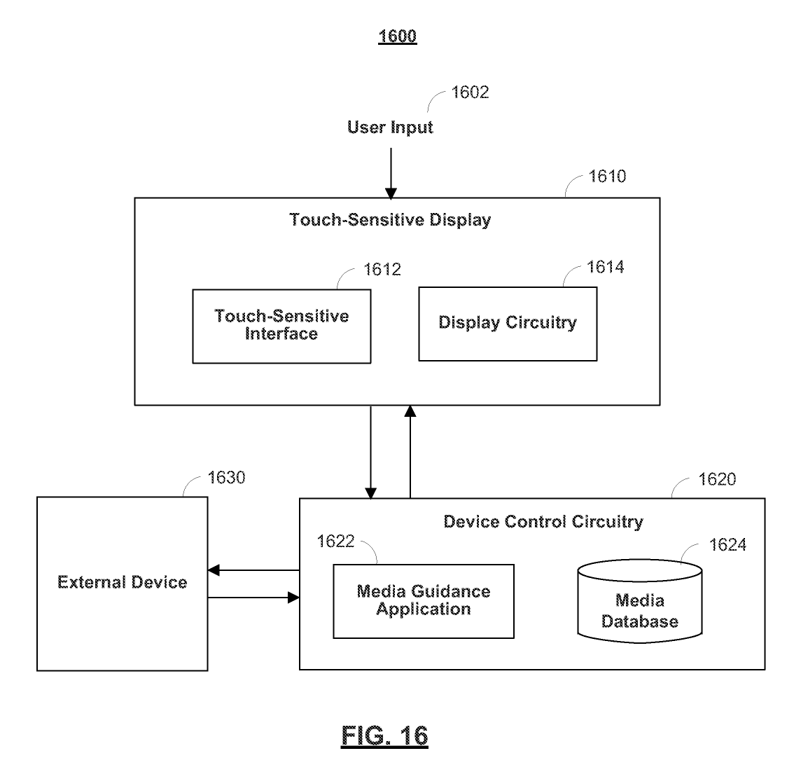

FIG. 15 shows a touch-sensitive device according to an illustrative embodiment of the invention. Users may access media content and the media guidance application (and its display screens described above) from one or more touch-sensitive devices. FIG. 15 shows a generalized embodiment of illustrative touch-sensitive device 1500. More specific implementations of touch-sensitive devices are discussed below in connection with FIG. 16. Touch-sensitive device 1500 may receive media content and data via input/output (hereinafter “I/O”) path 1502. I/O path 1502 may provide media content (e.g., broadcast programming, on-demand programming, Internet content, and other video or audio content) and data to control circuitry 1504, which includes processing circuitry 1506 and storage 1508. Control circuitry 1504 may be used to send and receive commands, requests, and other suitable data using I/O path 1502. I/O path 1502 may connect control circuitry 1504 (and specifically processing circuitry 1506) to one or more communications paths (described below). I/O functions may be provided by one or more of these communications paths, but are shown as a single path in FIG. 15 to avoid overcomplicating the drawing.

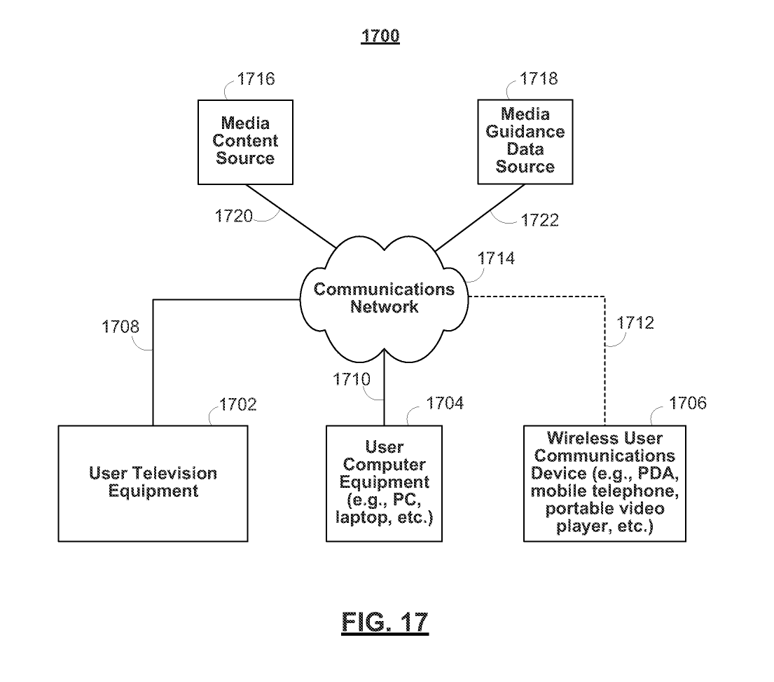

Control circuitry 1504 may be based on any suitable processing circuitry 1506 such as processing circuitry based on one or more microprocessors, microcontrollers, digital signal processors, programmable logic devices, etc. In some embodiments, control circuitry 1504 executes instructions for a media guidance application stored in memory (i.e., storage 1508). In client-server based embodiments, control circuitry 1504 may include communications circuitry suitable for communicating with a guidance application server or other networks or servers. Communications circuitry may include a wireless transmitter and/or receiver for communicating with other equipment. Such communications may involve the Internet or any other suitable communications networks or paths (which is described in more detail in connection with FIG. 17). In addition, communications circuitry may include circuitry that enables peer-to-peer communication between devices, or communication between devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 1508 that is part of control circuitry 1504. Storage 1508 may include one or more of the above types of storage devices. For example, touch-sensitive device 1500 may include a hard drive and/or Flash memory. Storage 1508 may be used to store various types of media content described herein and guidance application data, including media content information, guidance application settings, user preferences or profile information, or other data used in operating the guidance application. Nonvolatile memory may also be used (e.g., to launch a boot-up routine and other instructions).

Control circuitry 1504 may include video generating circuitry and/or tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1504 may include scaler circuitry for upconverting and downconverting media into the preferred output format of the user equipment 1500. Circuitry 1504 may also include digital-to-analog converter circuitry and analog-to-digital converter circuitry for converting between digital and analog signals. The tuning and encoding circuitry may be used by the device to receive and to display, to play, or to record media content. The tuning and encoding circuitry may also be used to receive guidance data. The circuitry described herein, including for example, the tuning, video generating, encoding, decoding, scaler, audio processing, and analog/digital circuitry, or may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1508 is provided as a separate device from user equipment 1500, the tuning and encoding circuitry (including multiple tuners) may be associated with storage 1508. Control circuitry 1504 may also include one or more video graphic processors and/or digital display driving circuitry.

A user may control the control circuitry 1504 using touch sensitive display 1520. Touch sensitive display 1520 may include various components that enable a screen to function both as an output display and as a touch-sensitive input interface. For example, touch sensitive display 1520 may include interface circuitry 1510 and display circuitry 1512. Although shown as two separate components, it should be understood that interface circuitry 1510 and display circuitry 1512 may be integrated into the same circuit or hardware component, and may be interconnected physically (e.g., layered) and/or electrically. User input interface 1510 may include any suitable touch-sensitive interface elements, such as a grid of resistive and/or capacitive elements. Generally, user input interface 1510 may implement a touch-sensitive screen using resistive, capacitive, acoustic, or optical technologies, or any other suitable touch-sensitive display technology or combination thereof. User input interface 1510 is capable of detecting a user's touch anywhere in the display area of the screen, and includes circuitry capable of outputting the location of the user's touch within the display area. In some embodiments, user input interface 1510 implements multi-touch technology, and includes circuitry capable of outputting multiple locations corresponding to multiple contact points within the display area.

Display 1512 may be provided as a stand-alone device or integrated with other elements of touch-sensitive device 1500. Display 1512 may be a liquid crystal display (LCD) or any other suitable equipment for displaying visual images. In some embodiments, display 1512 is HDTV-capable. Display 1512 may also, in some embodiments, implement In-Plane Switching (IPS) technology. Speakers 1514 may be provided as integrated with other elements of touch-sensitive device 1500 or may be stand-alone units. The audio component of videos, stored or streaming audio content, and other media content displayed on display 1512 may be played through speakers 1514. In some embodiments, the audio may be distributed to a receiver (not shown), which processes and outputs the audio via speakers 1514. As used herein, speakers 1514 are illustrative of, and may represent, any type of audio output device (e.g., headphones, a wireless headset, an audio output auxiliary port, etc.).

The guidance application may be implemented using any suitable architecture. For example, it may be a stand-alone application wholly implemented on touch-sensitive device 1500. In such an approach, instructions of the application are stored locally, and data for use by the application is downloaded on a periodic basis (e.g., from the a remote database, Internet service, or using another suitable approach). In another embodiment, the media guidance application is a client-server based application. Data for use by a thick or thin client implemented on touch-sensitive device 1500 is retrieved on-demand by issuing requests to a server remote to the touch-sensitive device 1500. In one example of a client-server based guidance application, control circuitry 1504 runs a web browser that interprets web pages provided by a remote server. For example, in embodiments in which the media guidance application is a web site or other internet-based application, the display screens of FIGS. 1-14 (discussed above), may be displayed to the user through a web browser implemented using control circuitry 1504. As another example, the display screens of FIGS. 1-14 may be displayed on display 1512. User indications and interaction with the display screens of FIGS. 1-14 may be received with touch-sensitive display 1520 and processed by circuitry 1506.

In yet other embodiments, the media guidance application is downloaded and interpreted or otherwise run by an interpreter or virtual machine (run by control circuitry 1504). In some embodiments, the guidance application may be encoded in the ETV Binary Interchange Format (EBIF), received by control circuitry 1504 as part of a suitable feed, and interpreted by a user agent running on control circuitry 1504. For example, the guidance application may be a EBIF widget. In other embodiments, the guidance application may be defined by a series of JAVA-based files that are received and run by a local virtual machine or other suitable middleware executed by control circuitry 1504. In some of such embodiments (e.g., those employing MPEG-2 or other digital media encoding schemes), the guidance application may be, for example, encoded and transmitted in an MPEG-2 object carousel with the MPEG audio and video packets of a program. In still other embodiments, the media guidance application may be composed of one or more Flash files that are received and run by suitable middleware executed by control circuitry 1504.

FIG. 16 shows a simplified diagram of an interactive media system 1600 according to an illustrative embodiment of the invention. Touch-sensitive display 1610 and device control circuitry 1620 may be equivalent to touch-sensitive display 1520 and control circuitry 1504 of user equipment device 1500 of FIG. 15, respectively. In addition to the features and functionalities described above, in connection with FIGS. 1-14, touch-sensitive display 1610 and device control circuitry 1620 may implement any of the technologies, and include any of the components, features, and functionalities described above in connection with FIG. 15. Control circuitry 1620 includes processing circuitry for executing media guidance application 1622. Control circuitry 1620 may also include processing circuitry for communicating with (i.e., reading and writing from) media database 1624. Database 1624 may be one or more relational databases or any other suitable storage mechanisms. Although database 1624 is shown as a single data store, one or more data stores may be used to implement a storage system.

Database 1624 may store media guidance data for a media guidance application. Database 1624 may store media-related information, including availability information (e.g., broadcast or streaming times), source information (e.g., broadcast channels, streaming address data, server/storage location), media titles, media descriptions, ratings information (e.g., parental control ratings, critic's ratings, etc.), genre or category information, actor information, logo data for broadcasters' or providers' logos, etc.), media format, on-demand information, or any other suitable media content information. The availability and source information included in database 1624 may be used by the media guidance application to provide media content information (e.g., as shown in the display screens of FIGS. 1-14) on display 1610, or to provide any other suitable media guidance display.

With continuing reference to FIG. 16, database 1624 may store advertising content for display in a media guidance application. Database 1624 may store advertising content in various forms, including text, graphics, images, video clips, content of any other suitable type, or references to remotely stored content. Database 1624 may also store links or identifiers to advertising content in other data stores. In some embodiments, database 1624 may store indexes for advertising content in other local data stores, or may store identifiers to remote storage systems, such as URLs to advertisements provided by web servers. Database 1624 may also store identifying information about each advertisement or advertisement element (e.g., associated advertiser, type of promotional, length of promotion, a television show, product, or service the advertisement is promoting, etc.), or may store indexes to locations in other local or remote storage systems where this information may be found.

Database 1624 may also store media content or information related to media content accessible through a media guidance application. For example, the media content and/or media related information displayed in the display screens and overlays of FIGS. 1-14 may be stored and/or downloaded to media database 1624. Upon display to the user, media database 1624 may be accessed to retrieve the requested information or media content.

With continuing reference to FIG. 16, device control circuitry 1620, which may have any of the features and functionalities of processing circuitry 1506 (FIG. 15), may access any of the information included in database 1624. Control circuitry 1620 may use this information to select, prepare, and display information on display 1610. In particular, control circuitry 1620 may use information obtained from database 1624 to provide a media guidance application 1622 to a user of the touch-sensitive device. For example, control circuitry 1620 may use this information to display the display screens of FIGS. 1-14. Control circuitry 1620 may also update information in database 1624 with data received from, for example, communications link 1502 of FIG. 15.

Touch-sensitive display 1610 may have any of the features and functionalities of touch-sensitive display 1520. In particular, touch-sensitive display 1610 may include both touch-sensitive interface components 1612 and display circuitry 1614. These elements may include any of the circuitry and may implement any of the technologies discussed above in connection with interface 1510 and display 1512 of FIG. 15. In addition, touch-sensitive interface components 1612 and display circuitry 1614 may be integrated into a single display. Accordingly, touch-sensitive display 1610 is capable of detecting and processing user input 1602. User input 1602 is generally a human touch in the form of a gesture, and may include one or more points of contact on the display screen. Gestures, as discussed above, may include tapping, slicking, sliding, or other suitable movements. It should be understood that an interface element, such as a stylus, may be used in place of direct human contact.

Touch-sensitive display 1610 may be integrated with device control circuitry 1620, or it may be a separate hardware device. In some embodiments, a touch-sensitive device may have its own touch screen and may additionally be connected to an external monitor, which itself may also be touch-sensitive. Touch-sensitive display 1610 may communicate with device control circuitry through any suitable communications lines and using any suitable communications protocol. In some embodiments, touch-sensitive display 1610 may include its own display drivers, while in other embodiments, control circuitry 1620 includes the display drivers for driving touch-sensitive display 1610.

With continuing reference to FIG. 16, control circuitry 1620 may communicate with an external device 1630. External device 1630 may be a server, user device, television equipment (e.g., a set-top box), a computer, a printer, a wireless router, or any other suitable device. In one embodiment, a user interacts with touch-sensitive display 1610 in order to control circuitry 1620, which in turn configures external device 1630. For example, a user may use the media guidance application 1622 to control watch and record functions of a digital video recorder (DVR).

FIG. 17 shows a diagram of a cross-platform interactive media system 1700 according to an illustrative embodiment of the invention. User equipment device 1500 of FIG. 15 (including touch-sensitive display 1610 and control circuitry 1620 of FIG. 16), may be implemented in system 1700 of FIG. 17 as user television equipment 1702, user computer equipment 1704 (e.g., a tablet computer), wireless user communications device 1706, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 1702 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 1704 may include a PC, a laptop, a tablet, a WebTV box, a personal computer television (PC/TV), a PC media server, a PC media center, or other user computer equipment. WEBTV is a trademark owned by Microsoft Corp. Wireless user communications device 1706 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 1702, user computer equipment 1704, and wireless user communications device 1706 may utilize at least some of the system features described above in connection with FIG. 15 and, as a result, include flexibility with respect to the type of media content available on the device. For example, user television equipment 1702 may be Internet-enabled allowing for access to Internet content, while user computer equipment 1704 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 1700, there is typically more than one of each type of user equipment device but only one of each is shown in FIG. 17 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user equipment devices may be coupled to communications network 1714. Namely, user television equipment 1702, user computer equipment 1704, and wireless user communications device 1706 are coupled to communications network 1714 via communications paths 1708, 1710, and 1712, respectively. Communications network 1714 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 1708, 1710, and 1712 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 1712 is drawn with dotted lines to indicate that in the exemplary embodiment shown in FIG. 17 it is a wireless path and paths 1708 and 1710 are drawn as solid lines to indicate they are wired paths (although these paths may be wireless paths, if desired). Communications with the user equipment devices may be provided by one or more of these communications paths, but are shown as a single path in FIG. 17 to avoid overcomplicating the drawing.

Although communications paths are not drawn between user equipment devices, these devices may communicate directly with each other via communication paths, such as those described above in connection with paths 1708, 1710, and 1712, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 1714.

System 1700 includes media content source 1716 and media guidance data source 1718 coupled to communications network 1714 via communication paths 1720 and 1722, respectively. Paths 1720 and 1722 may include any of the communication paths described above in connection with paths 1708, 1710, and 1712. Communications with the media content source 1716 and media guidance data source 1718 may be exchanged over one or more communications paths, but are shown as a single path in FIG. 17 to avoid overcomplicating the drawing. In addition, there may be more than one of each of media content source 1716 and media guidance data source 1718, but only one of each is shown in FIG. 17 to avoid overcomplicating the drawing. (The different types of each of these sources are discussed below.) If desired, media content source 1716 and media guidance data source 1718 may be integrated as one source device. Although communications between sources 1716 and 1718 with user equipment devices 1702, 1704, and 1706 are shown as through communications network 1714, in some embodiments, sources 1716 and 1718 may communicate directly with user equipment devices 1702, 1704, and 1706 via communication paths (not shown) such as those described above in connection with paths 1708, 1710, and 1712.

Media content source 1716 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, video streaming services and other media content providers. NBC is a trademark owned by the National Broadcasting Company, Inc., ABC is a trademark owned by the ABC, INC., and HBO is a trademark owned by the Home Box Office, Inc. Media content source 1716 may be the originator of media content (e.g., a television broadcaster, a Webcast provider, etc.) or may not be the originator of media content (e.g., an on-demand media content provider, an Internet provider of video content of broadcast programs for downloading, etc.). Media content source 1716 may include cable sources, satellite providers, on-demand providers, Internet providers, or other providers of media content. Media content source 1716 may also include a remote media server used to store different types of media content (including video content selected by a user), in a location remote from any of the user equipment devices.

Media content source 1716 (or source 1718) may receive data from user equipment devices 1702, 1704, and 1706. The data may also include requests or queries initiated from user equipment (e.g., devices 1702, 1704, and 1706) and responses to requests or queries initiated from server equipment (e.g., source 1718). In addition, media content source 1716 may receive monitoring data gathered by a media guidance application implemented on user equipment devices 1702, 1704, and 1706. For example, user interaction with the media guidance application may be monitored, compiled into a data set, and sent to source 1716. Monitoring data may include user viewing habits (e.g., which media content a user views or records, and when the user views or downloads the media content), user interaction with advertisements (e.g., which advertisements a user selects, and when a user selects the advertisement), user purchasing habits (e.g., what types of products or services a user orders, and when the orders are placed), and other suitable information.

Sources 1716 and/or 1718 may collect and correlate data received from multiple users to determine commonalities between users, prevalent behavior patterns, and popular features, queries, and preferences. For example, source 1716 may compile the media content preferences of a number of users to determine the most popular artists, genres, songs, etc (e.g., to display recommended media content). As another example, source 1716 may compile monitoring data of user interaction with the media guidance application to determine the most frequently accessed features, options, and display screens. In addition, source 1716 may compile monitoring data to determine the most effective advertisements and advertisement placement (e.g., location and timing). Source 1716 may use these determinations and other analyses of user generated data to provide updated features and new services to other users. For example, based on a determination of popular video content, source 1716 may provide advertisements or alerts to other users about future broadcasts or delivery options for the popular video content.

Media guidance data source 1718 may provide media guidance data, such as media listings, media-related information, availability and source information (e.g., broadcast times, broadcast channels, server/storage information), media titles, media descriptions, ratings information (e.g., parental control ratings, critic's ratings, etc.), genre or category information, actor information, logo data for broadcasters' or providers' logos, etc., media format, advertisement information (e.g., text, images, media clips, etc.), on-demand information, and any other type of guidance data that is helpful for a user to navigate among and locate desired media selections.

Media guidance data source 1718 may additionally provide advertisement information (e.g., text, images, media clips, etc.) to the user equipment devices. The advertisement information may include any advertisements used by the media guidance application to provide advertisements to a user. The advertising information provided to the user devices may have originated from any suitable source, which may or may not be media guidance data source 1718. In some embodiments, the advertising information may have originated from various different advertisers or program sponsors, and may have originated from media content source 1716.

Media guidance application data, including advertisement information, may be provided to the user equipment devices using any suitable approach or combination of approaches. In some embodiments, the guidance application may be a stand-alone interactive television program guide that receives program guide data via a data feed (e.g., a continuous feed, trickle feed, or data in the vertical blanking interval of a channel). Program schedule data and other guidance data, such as advertising information or audio asset information, may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media content source 1716 or media guidance data source 1718 may be provided to users' equipment using a client-server approach. For example, a guidance application client residing on the user's equipment may initiate sessions with source 1718 to obtain guidance data when needed. Media guidance data source 1718 may provide user equipment devices 1702, 1704, and 1706 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 1504 of user equipment device 1500 (FIG. 15) and partially on a remote server as a server application (e.g., media guidance data source 1718). The guidance application displays may be generated by media content source 1716, media guidance data source 1718, or a combination of these sources and transmitted to the user equipment devices. Sources 1716 and 1718 may also transmit data for storage on the user equipment, which then generates the guidance application displays based on instructions processed by control circuitry.

Referring again to FIG. 17, media guidance system 1700 is intended to illustrate a number of approaches, or network configurations, by which user equipment devices and sources of media content and guidance data may communicate with each other for the purpose of accessing media, media information, and providing media guidance. The present invention may be applied in any one or a subset of these approaches, or in a system employing other approaches for delivering media and providing media content, information, and guidance.

The following flow charts serve to illustrate processes involved in some embodiments of the invention. Where appropriate, these processes may, for example, be implemented completely in the processing circuitry of a user equipment device (e.g., control circuitry 1504 of FIG. 15) or may be implemented at least partially in a remote server (e.g., server 1716 of FIG. 17). It should be understood that the steps of the flow charts are merely illustrative and any of the depicted steps may be modified, omitted, or rearranged, two or more of the steps may be combined, or any additional steps may be added, without departing from the scope of the invention.

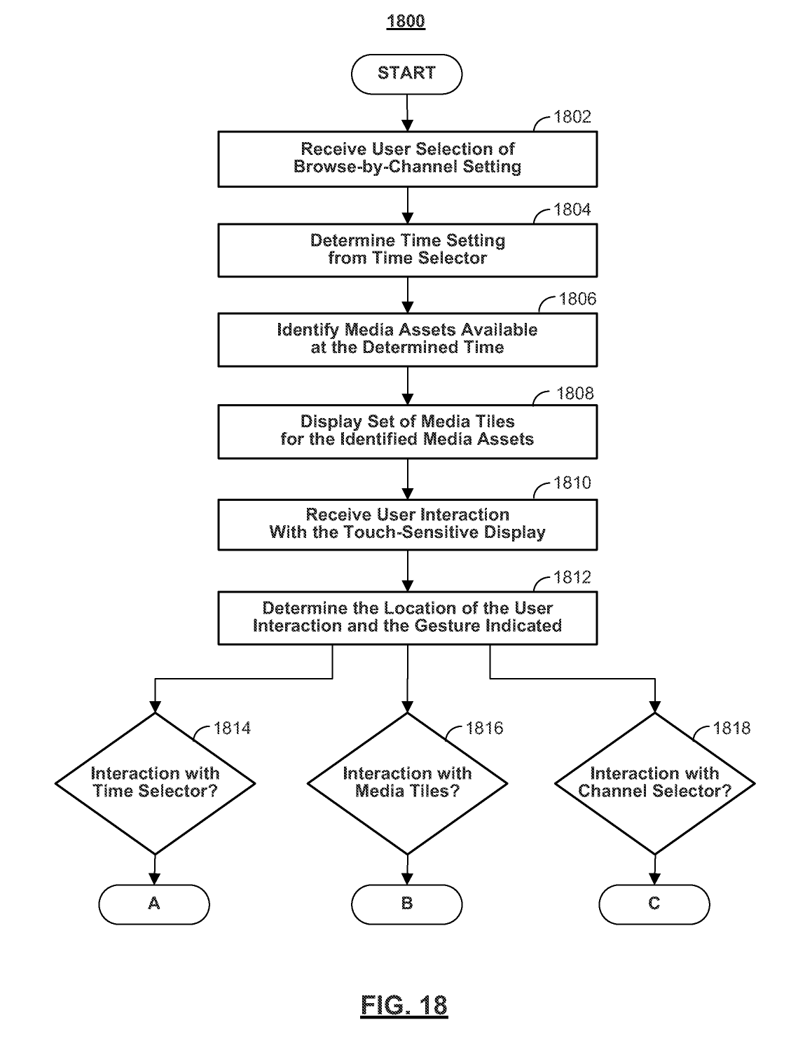

Turning to FIG. 18, illustrative flow chart 1800 is shown depicting an exemplary process for navigating media content information in browse-by-channel mode, in accordance with some embodiments of the present invention. At step 1802, the media guidance application receives a user selection of the browse-by-channel setting, which adjusts the browse settings of the guidance application so that it operates in browse-by-channel mode. As described above, in connection with FIG. 6, browse-by-channel mode allows the user to navigate media content information for media assets available from a number of different media sources (e.g., television channels, web streaming services, etc.) at the same time. At step 1804, the time setting is determined from the time selector. The time setting, as explained above in connection with FIG. 6, is indicated by the time slider, and corresponds to a particular selector position on the time selector. The time selector, for instance, may provide selector positions for the time of day in 30 minute increments. In one approach, the time setting may default to a selector position indicating a time closest to, but prior to, the current time.

At step 1806, media assets available at the time determined in step 1804 may be identified. For example, the media guidance application may search a local or remote database storing media content information. This information may include availability and/or source information for a number of media assets. Accordingly, the availability information may be searched to identify a group of media assets available at the desired time. These media assets may be available from any number of media sources. At step 1808, media tiles representing the identified media assets may be displayed. A media tile, as described above in connection with FIG. 6, may be an image, title, or any other suitable visual indication associated with a media asset. In an embodiment, the media tiles may be displayed linearly in a row, and may be scrollable by the user.

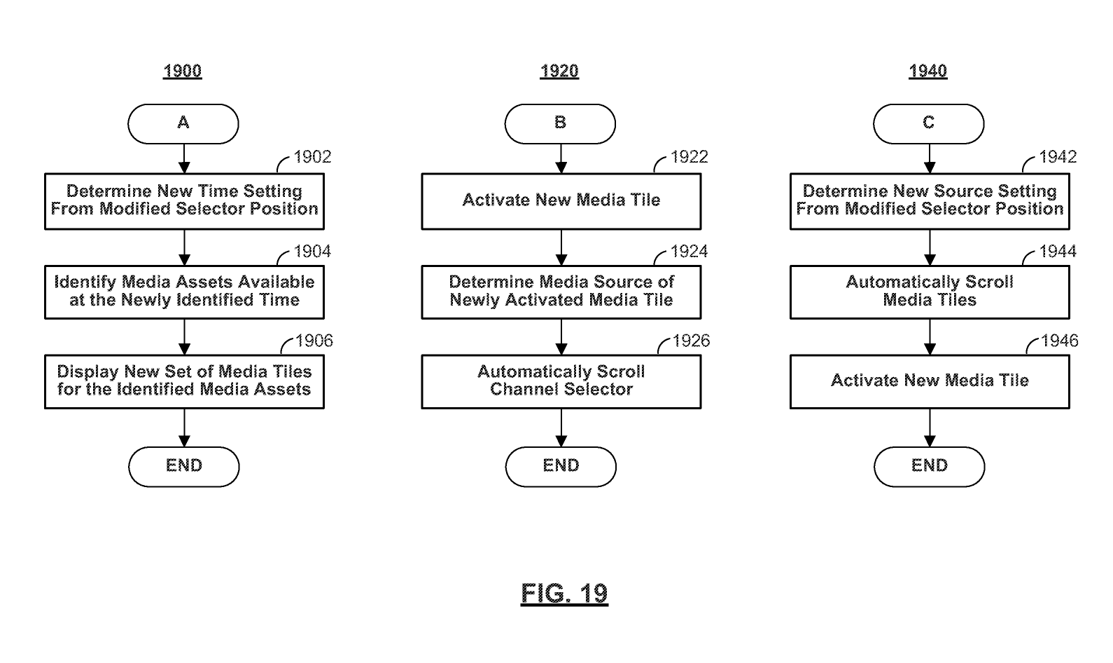

At step 1810, the touch-sensitive display (e.g., touch sensitive interface 1612 of FIG. 16) receives user interaction, e.g., a gesture, within the display area of the screen. At step 1812, the display circuitry (e.g., control circuitry 1620 of FIG. 16), or other suitable processing circuitry, determines the location of the user interaction within the display screen, as well as the gesture indicated. For example, it may be determined that the user performed a tap, flick, or slide gesture in the vicinity of a region or display element on the display screen. If the user interaction was in the area of the time selector, process 1800 continues with process 1900 (FIG. 19), as shown at step 1814. If the user interaction was in the area of the media tiles, process 1800 continues with process 1920 (FIG. 19), as shown at step 1816. Finally, if the user interaction was in the area of the channel selector, process 1800 continues with process 1940 (FIG. 19), as shown at step 1818.

Turning to FIG. 19, illustrative flow charts 1900, 1920, and 1940 are shown depicting exemplary processes for navigating media content information in browse-by-channel mode, in accordance with some embodiments of the present invention. Process 1900 is executed when the location of user interaction with the touch-sensitive display is determined, in step 1814 of FIG. 18, to be in the area of the screen defining the time selector. As described above in connection with FIG. 6, the user interaction may result in the indication of a new time, i.e., time slider may indicate a new selector position. At step 1902, the new time setting is determined from the selector position in the time selector. At step 1904, a second group of media assets are identified for the new time setting. Specifically, the media guidance application searches for media assets available at the new time indicated in the time selector. This identification process may involve the same techniques and functionality as was described in connection with step 1806 of FIG. 18. Finally, at step 1906, the new set of media assets that were identified in step 1904 are displayed to the user, e.g., as shown in FIG. 6.

Process 1920 is executed when the location of user interaction with the touch-sensitive display is determined, in step 1816 of FIG. 18, to be in the area of the screen defining the media tiles (e.g., region 640 of FIG. 6). As described above in connection with FIG. 6, one of the displayed media tiles may always be active at any particular time. At step 1922, in response to the user interaction with the media tiles, the media tiles may scroll and a new media tile may be activated. The active media tile may be displayed in the center of the display region, and may respond to further user interaction, for instance, by displaying additional information related to the media asset. At step 1924, the media guidance application determines the media source from which the media asset corresponding to the active media tile is available. For example, the media asset may be associated with a channel or streaming video service. At step 1926, the media guidance application automatically scrolls the channel selector so that the channel slider indicates the determined media source. In this manner, the channel selector is updated to indicate the media source corresponding to the currently active media tile.

Process 1940 is executed when the location of user interaction with the touch-sensitive display is determined, in step 1818 of FIG. 18, to be in the area of the screen defining the channel selector. As described above in connection with FIG. 6, the user interaction may result in the indication of a new media source, i.e., channel slider may indicate a new selector position. At step 1942, the new media source setting is determined from the selector position in the channel selector. At step 1944, the media guidance application automatically scrolls the media tiles to locate the media asset available from the media source indicated in the channel selector. At step 1946, the media tile corresponding to the located media asset is activated. In this manner, the active media tile is updated to be consistent with the currently indicated selector position (i.e., media source) in the channel selector.

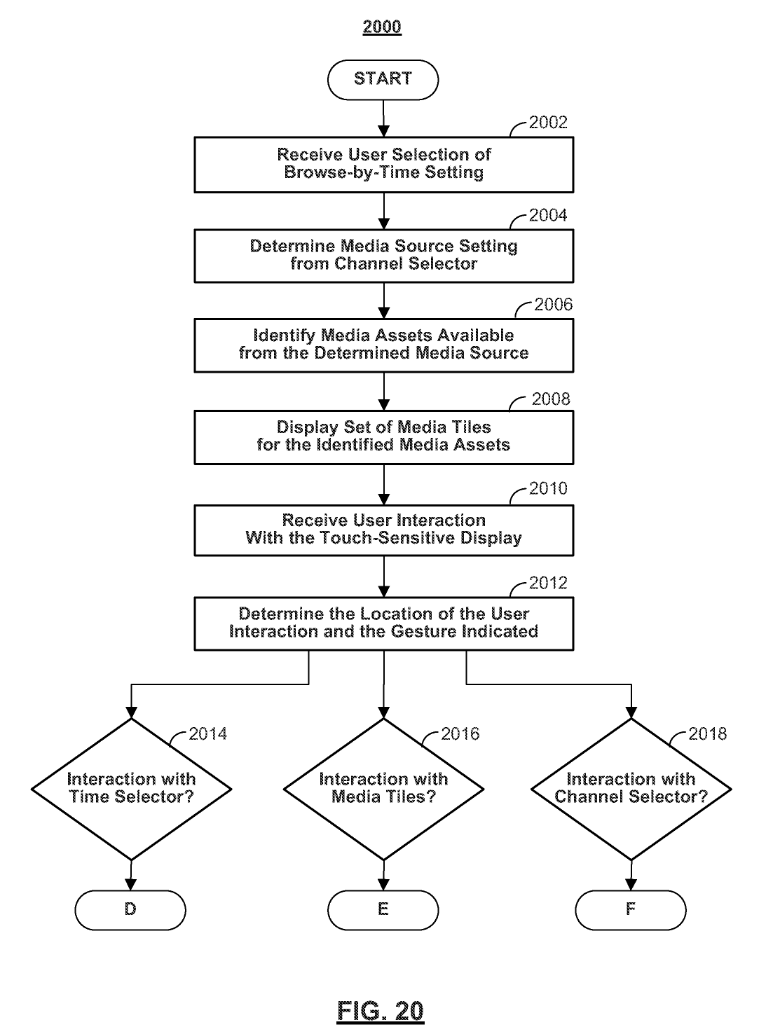

Turning to FIG. 20, illustrative flow chart 2000 is shown depicting an exemplary process for navigating media content information in browse-by-time mode, in accordance with some embodiments of the present invention. At step 2002, the media guidance application receives a user selection of the browse-by-time setting, which adjusts the browse settings of the guidance application so that it operates in browse-by-time mode. As described above, in connection with FIG. 7, browse-by-time mode allows the user to navigate media content information for media assets available at different times from the same media source. At step 2004, the media source setting is determined from the channel selector. The media source setting, as explained above in connection with FIG. 7, is indicated by the channel slider, and corresponds to a particular selector position on the channel selector. The media source selector, for instance, may provide selector positions for different channels and/or streaming video services. In one approach, the media source setting may default to a pre-determined selector position.

At step 2006, media assets available from the media source determined in step 2004 may be identified. For example, the media guidance application may search a local or remote database storing media content information. This information may include availability and/or source information for a number of media assets. Accordingly, the source information may be searched to identify a group of media assets available from the desired media source. These media assets may be available at different times of day. At step 2008, media tiles representing the identified media assets may be displayed. In an embodiment, the media tiles may be displayed linearly in a row, and may be scrollable by the user.

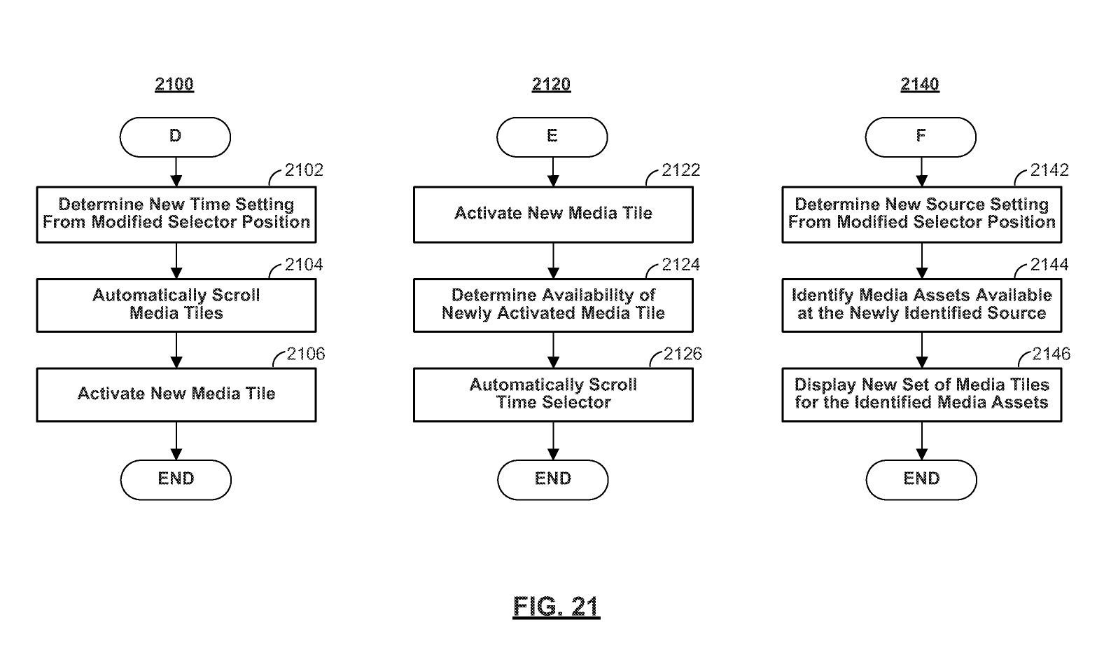

At step 2010, the touch-sensitive display (e.g., touch sensitive interface 1612 of FIG. 16) receives user interaction, e.g., a gesture, within the display area of the screen. At step 2012, the display circuitry (e.g., control circuitry 1620 of FIG. 16), or other suitable processing circuitry, determines the location of the user interaction within the display screen, as well as the gesture indicated. For example, it may be determined that the user performed a tap, flick, or slide gesture in the vicinity of a region or display element on the display screen. If the user interaction was in the area of the time selector, process 2000 continues with process 2100 (FIG. 21), as shown at step 2014. If the user interaction was in the area of the media tiles, process 2000 continues with process 2120 (FIG. 21), as shown at step 2016. Finally, if the user interaction was in the area of the channel selector, process 2000 continues with process 2140 (FIG. 21), as shown at step 2018.

Turning to FIG. 21, illustrative flow charts 2100, 2120, and 2140 are shown depicting exemplary processes for navigating media content information in browse-by-time mode, in accordance with some embodiments of the present invention. Process 2100 is executed when the location of user interaction with the touch-sensitive display is determined, in step 2014 of FIG. 20, to be in the area of the screen defining the time selector. As described above in connection with FIGS. 6 and 7, the user interaction may result in the indication of a new time, i.e., time slider may indicate a new selector position. At step 2102, the new time setting is determined from the selector position in the time selector. At step 2104, the media guidance application automatically scrolls the media tiles to locate the media asset available at the new time indicated in the time selector. At step 2106, the media tile corresponding to the located media asset is activated. In this manner, the active media tile is updated to be consistent with the currently indicated selector position (i.e., time) in the time selector.

Process 2120 is executed when the location of user interaction with the touch-sensitive display is determined, in step 2016 of FIG. 20, to be in the area of the screen defining the media tiles (e.g., region 740 of FIG. 7). As described above in connection with FIGS. 6 and 7, one of the displayed media tiles may always be active at any particular time. At step 2122, in response to the user interaction with the media tiles, the media tiles may scroll and a new media tile may be activated. The active media tile may be displayed in the center of the display region, and may respond to further user interaction, for instance, by displaying additional information related to the media asset. At step 2124, the media guidance application determines the time at which the media asset corresponding to the active media tile is available. For example, the media asset may be available at 6 PM, 6:30 PM, etc. At step 2126, the media guidance application automatically scrolls the time selector so that the time slider indicates the determined time. In this manner, the time selector is updated to indicate the availability corresponding to the currently active media tile.

Finally, process 2140 is executed when the location of user interaction with the touch-sensitive display is determined, in step 2018 of FIG. 20, to be in the area of the screen defining the channel selector. As described above in connection with FIGS. 6 and 7, the user interaction may result in the indication of a new media source, i.e., channel slider may indicate a new selector position. At step 2142, the new media source setting is determined from the selector position in the channel selector. At step 2144, a second group of media assets are identified for the new media source setting. Specifically, the media guidance application searches for media assets available from the media source newly indicated in the channel selector. This identification process may involve the same techniques and functionality as was described in connection with step 2006 of FIG. 20. At step 2106, the new set of media assets that were identified in step 2104 are displayed to the user, e.g., as shown in region 740 of FIG. 7.

It is to be understood that while certain forms of the present invention have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for navigating media information using a media guidance application implemented on a portable device with a touch-sensitive display, the method comprising:
displaying, on the touch-sensitive display, a display screen with a media asset information region and an availability information region;
displaying, in the media asset information region of the display screen, a first portion of a first selectable list of media objects each representing one of a plurality of media assets, wherein the media objects are arranged linearly and adjacent to one another;
displaying, in the availability information region of the display screen and parallel to the selectable list of media objects, a selector that includes:
a plurality of selector positions each corresponding to a different time or media source; and
a slider that indicates a first selector position in the plurality of selector positions;
in response to receiving a first user actuation of the touch-sensitive display at a location within the media asset information region, scrolling the first selectable list of media objects along a first direction to display a second portion of the first selectable list of media objects;
in response to receiving a second user actuation of the touch-sensitive display at a location within the availability information region, changing the position of the slider to indicate a second selector position in the plurality of selector positions; and
replacing the first selectable list of media objects with a second selectable list of media objects, wherein each of the media objects in the second selectable list represents a media asset available at the time or media source corresponding to the second selector position.

2. The method of claim 1, wherein each of the plurality of selector positions corresponds to a different time, and wherein the media objects in the first selectable list represent media assets available from different media sources at the time corresponding to the first selector position, and the media objects in the second selectable list represent media assets available from different media sources at the time corresponding to the second selector position.

3. The method of claim 2 further comprising:
displaying a selectable element in the availability information region of the display screen;
receiving a third user actuation of the touch-sensitive display at a location within the selectable element;
in response to receiving the third user actuation, modifying the selector so that each of the plurality of selector positions corresponds to a different media source;
replacing the second selectable list of media objects with a third selectable list of media objects, wherein the media objects in the third selectable list represent media assets available at different times from the media source corresponding to a third selector position in the plurality of selector positions.

4. The method of claim 3 further comprising:
receiving a fourth user actuation of the touch-sensitive display at a location within the availability information region; and
in response to receiving the fourth user actuation, changing the position of the slider to indicate a fourth selector position in the plurality of selector positions; and
replacing the third selectable list of media objects with a fourth selectable list of media objects, wherein the media objects in the fourth selectable list represent media assets available at different times from the media source corresponding to the fourth selector position.

5. The method of claim 1, wherein each of the plurality of selector positions corresponds to a different media source, and wherein the media objects in the first selectable list represent media assets available at different times from the media source corresponding to the first selector position, and the media objects in the second selectable list represent media assets available at different times from the media source corresponding to the second selector position.

6. The method of claim 5 further comprising:
displaying a selectable element in the availability information region of the display screen;
receiving a third user actuation of the touch-sensitive display at a location within the selectable element;
in response to receiving the third user actuation, modifying the selector so that each of the plurality of selector positions corresponds to a different time;
replacing the second selectable list of media objects with a third selectable list of media objects, wherein the media objects in the third selectable list represent media assets available from different media sources at the time corresponding to a third selector position in the plurality of selector positions.

7. The method of claim 6 further comprising:
receiving a fourth user actuation of the touch-sensitive display at a location within the availability information region; and
in response to receiving the fourth user actuation, changing the position of the slider to indicate a fourth selector position in the plurality of selector positions; and
replacing the third selectable list of media objects with a fourth selectable list of media objects, wherein the media objects in the fourth selectable list represent media assets available from different media sources at the time corresponding to the fourth selector position.

8. The method of claim 1 further comprising:
identifying, during the first user actuation of the touch-sensitive display, a first actuated area on the touch-sensitive display at a first time instant and a second actuated area on the touch-sensitive display at a second time instant, wherein the first time instant precedes the second time instant; and
determining the first direction by comparing the relative locations of the first actuated area and the second actuated area.

9. The method of claim 1 further comprising:
displaying, in the media asset information region of the display screen, a plurality of progress indicators each indicative of an elapsed time of a different one of the plurality of media assets.

10. The method of claim 9, wherein each of the plurality of progress indicators is displayed adjacent to one of the media objects representing the corresponding media asset, and wherein the plurality of progress indicators scroll together with the media objects.

11. The method of claim 1, wherein each of the media objects is an image tile that identifies the corresponding media asset.

12. The method of claim 11, wherein the display screen is a first display screen and each of the image tiles is selectable, the method further comprising:
receiving a third user actuation of the touch-sensitive display at a location within a given image tile; and
in response to receiving the third user actuation, displaying a second display screen that includes related information associated with the media asset corresponding to the given image tile.

13. A portable touch-sensitive device implementing a media guidance application for navigating media information, the device comprising:
a touch-sensitive display configured to:
provide a display screen with a media asset information region and an availability information region;
display, in the media asset information region of the display screen, a first portion of a first selectable list of media objects each representing one of a plurality of media assets, wherein the media objects are arranged linearly and adjacent to one another; and
display, in the availability information region of the display screen and parallel to the selectable list of media objects, a selector that includes a plurality of selector positions each corresponding to a different time or media source, and a slider that indicates a first selector position in the plurality of selector positions; and
a processor configured to:
scroll, in response to a first user actuation of the touch-sensitive display at a location within the media asset information region, the first selectable list of media objects along a first direction to display a second portion of the first selectable list of media objects;
modify, in response to a second user actuation of the touch-sensitive display at a location within the availability information region, the position of the slider to indicate a second selector position in the plurality of selector positions; and
replace the first selectable list of media objects with a second selectable list of media objects, wherein each of the media objects in the second selectable list represents a media asset available at the time or media source corresponding to the second selector position.

14. The portable touch-sensitive device of claim 13, wherein each of the plurality of selector positions corresponds to a different time, and wherein the media objects in the first selectable list represent media assets available from different media sources at the time corresponding to the first selector position, and the media objects in the second selectable list represent media assets available from different media sources at the time corresponding to the second selector position.

15. The portable touch-sensitive device of claim 14, wherein the processor is further configured to:
display a selectable element in the availability information region of the display screen;
receive a third user actuation of the touch-sensitive display at a location within the selectable element;
in response to receiving the third user actuation, modify the selector so that each of the plurality of selector positions corresponds to a different media source; and
replace the second selectable list of media objects with a third selectable list of media objects, wherein the media objects in the third selectable list represent media assets available at different times from the media source corresponding to a third selector position in the plurality of selector positions.

16. The portable touch-sensitive device of claim 15, wherein the processor is further configured to:
receive a fourth user actuation of the touch-sensitive display at a location within the availability information region;
in response to receiving the fourth user actuation, change the position of the slider to indicate a fourth selector position in the plurality of selector positions; and
replace the third selectable list of media objects with a fourth selectable list of media objects, wherein the media objects in the fourth selectable list represent media assets available at different times from the media source corresponding to the fourth selector position.

17. The portable touch-sensitive device of claim 13, wherein each of the plurality of selector positions corresponds to a different media source, and wherein the media objects in the first selectable list represent media assets available at different times from the media source corresponding to the first selector position, and the media objects in the second selectable list represent media assets available at different times from the media source corresponding to the second selector position.

18. The portable touch-sensitive device of claim 17, wherein the processor is further configured to:
display a selectable element in the availability information region of the display screen;
receive a third user actuation of the touch-sensitive display at a location within the selectable element;
in response to receiving the third user actuation, modify the selector so that each of the plurality of selector positions corresponds to a different time; and
replace the second selectable list of media objects with a third selectable list of media objects, wherein the media objects in the third selectable list represent media assets available from different media sources at the time corresponding to a third selector position in the plurality of selector positions.

19. The portable touch-sensitive device of claim 18, wherein the processor is further configured to:
receive a fourth user actuation of the touch-sensitive display at a location within the availability information region;
in response to receiving the fourth user actuation, change the position of the slider to indicate a fourth selector position in the plurality of selector positions; and
replace the third selectable list of media objects with a fourth selectable list of media objects, wherein the media objects in the fourth selectable list represent media assets available from different media sources at the time corresponding to the fourth selector position.

20. The portable touch-sensitive device of claim 13, wherein the processor is further configured to:
identify, during the first user actuation of the touch-sensitive display, a first actuated area on the touch-sensitive display at a first time instant and a second actuated area on the touch-sensitive display at a second time instant, wherein the first time instant precedes the second time instant; and
determine the first direction by comparing the relative locations of the first actuated area and the second actuated area.

21. The portable touch-sensitive device of claim 13, wherein the processor is further configured to:
display, in the media asset information region of the display screen, a plurality of progress indicators each indicative of an elapsed time of a different one of the plurality of media assets.

22. The portable touch-sensitive device of claim 21, wherein each of the plurality of progress indicators is displayed adjacent to one of the media objects representing the corresponding media asset, and wherein the plurality of progress indicators scroll together with the media objects.

23. The portable touch-sensitive device of claim 13, wherein each of the media objects is an image tile that identifies the corresponding media asset.

24. The portable touch-sensitive device of claim 23, wherein the display screen is a first display screen and each of the image tiles is selectable, and wherein the processor is further configured to:
receive a third user actuation of the touch-sensitive display at a location within a given image tile; and
in response to receiving the third user actuation, display a second display screen that includes related information associated with the media asset corresponding to the given image tile.

25.-36. (canceled)
